(19) United States
(12) Patent Application Publication
(10) Pub. No.: US 2025/0166025 A1
(43) Pub. Date: May 22, 2025

(54) COMPUTER SYSTEM FOR MONITORING BUSINESS USAGE

(71) Applicant: Lynxit LLC., Rexburg, ID (US)

(72) Inventor: Colin Cardenaz, Rexburg, ID (US)

(73) Assignee: Lynxit LLC., Rexburg, ID (US)

(21) Appl. No.: 18/518,437

(22) Filed: Nov. 22, 2023

(51) Int. Cl. G06Q 30/0282; G06Q 10/02; G06Q 30/0283

(52) U.S. Cl. CPC G06Q 30/0282; G06Q 10/02; G06Q 30/0283

(57) ABSTRACT

A computer system for monitoring business usage comprises a processor and a non-transitory computer-readable storage medium. Various modules are stored on the storage medium. The business location receive module acquires business geolocations through the network interface card. The business time usage module receives a usage goal for a specific business geolocation. Utilizing a global positioning system-enabled unit, the business usage module tracks user geolocation, identifies customer presence at business locations, and monitors time against the usage goal. The reporting module receives usage time at a business geolocation.

### TECHNICAL FIELD

The disclosure generally relates to a computer system for monitoring business usage. More specifically, this disclosure relates to a computer system monitoring business usage based on time and geolocation.

### BACKGROUND

Some businesses struggle to attract new customers. Various businesses have arisen to assist other businesses with their marketing efforts. Some businesses currently spend money on digital marketing efforts to attract new customers. Groupon® e-commerce marketplace allows businesses to provide coupons, which may attract new customers with varying degrees of success. The Yelp® for Business service provides listings of businesses, sponsored ads, and customer reviews. Some users of services like the Yelp® for Business service have encountered reviews of businesses that are misleading, biased, or fake. A need exists for businesses, including businesses with a limited marketing budget, to have more genuine, positive customer reviews. Another need exists for businesses to increase the amount of new and returning customers.

### BRIEF SUMMARY

Embodiments of a system are disclosed. For purposes of this disclosure, a smart device refers to a smartphone, a tablet, or other similar device configured to communicate with the disclosed computer system.

In some aspects, the techniques described herein relate to a computer system for monitoring business usage, the computer system including: a processor; a network interface card, communicatively connected to the processor; a time measurement system, the time measurement system communicatively connected to the processor; a non-transitory computer-readable storage medium, the non-transitory computer-readable storage medium including a number of modules, each module consisting of a combination of hardware and computer code that cause the processor to cause the computer system to perform a particular task, the modules including: a business location receive module, the business location receive module receiving, using the network interface, a plurality of participating business identifiers wherein each participating business identifier corresponds to a participating business entity of a plurality of participating business entities, and a plurality of sets of global positioning system coordinates wherein each set of global positioning system coordinates corresponds to one of the plurality of participating business identifiers; a business time usage module, the business time usage module receiving a plurality of business time usage goals wherein each of the plurality of business time usage goals corresponds to one of the plurality of participating business identifiers; a business usage module, the business usage module determining whether a first user was physically proximate to the one of the plurality of participating business entities for at least a length of time equal to or greater than the business time usage goal corresponding to the one of the business entities, wherein after the business usage module has determined that the first user was physically proximate to the one of the plurality of participating business entities for at least a length of time equal to or greater than the business time usage goal corresponding to the one of the participating business entities, then the business usage module stores, in the business usage module, a designation of customer status of the one of the participating business entities for the first user and instructs a customer review module to send a request to the first user requesting that the first user provide customer feedback to the computer system about the one of the business entities.

In some aspects, the techniques described herein relate to a computer system in claim 1, wherein the non-transitory storage medium further includes: a calendaring module, the calendaring module receiving scheduled events from businesses and sending instructions, to a smart device of the first user, to display a plurality of scheduled events; a business receive module, receiving a number of participating business identifiers, each of the number of participating business identifiers identifying a participating business entity, of a plurality of participating business entities, that is configured to schedule reservations made via a smart device communicatively-coupled with the computer system; a business availability receive module, receiving, for each of the number of participating business identifiers, of the plurality of participating business entities, a number of times for each of the plurality of participating business entities configured to schedule reservations made via the smart device communicatively-coupled with the computer system; a pricing module, receiving a number of pricing options corresponding to the number of times for each of the plurality of business entities configured to schedule reservations made via the smart device communicatively-coupled with the computer system; an off-hour business usage module, the off-hour business usage module receiving a set of global positioning coordinates, associated with the smart device, from the smart device and measuring usage of the participating business during off-hours, for each of the number of businesses, by the smart device communicatively-coupled with the computer system.

In some aspects, the techniques described herein relate to a computer system in claim 2, where a reporting module further reports the usage time at the participating business location as it relates to the number of times for each of the number of participating businesses which is allowing reservations to be scheduled using the computer system determines when the first user used the participating business during a time when the prices were in effect, where the pricing module receives a number of prices for business benefits and times when the prices remain in effect.

In some aspects, the techniques described herein relate to a computer system, further including a revenue generation module, the revenue generation module calculating revenue based on the time the first user was present at a participating business and the number of prices for business benefits.

In some aspects, the techniques described herein relate to a computer system, further including a business objective module, the business objective module receiving a business objective to direct how the computer system presents content to the first user to help the business achieve its objective.

In some aspects, the techniques described herein relate to a computer system, wherein the reporting module reports an amount of time that the smart device communicatively-coupled with the computer system is physically proximate to the participating business and compares the amount of time to an expected amount of time that the smart device needs to be proximate to a business to demonstrate usage. In some aspects, the techniques described herein relate to a computer system for monitoring business usage, the computer system including: a processor; a network interface card, communicatively connected to the processor; a global positioning system, the global positioning system communicatively connected to the processor; a user display, the user display communicatively connected to the processor; a time measurement system, the time measurement system communicatively connected to the processor; a non-transitory computer-readable storage medium, the non-transitory computer-readable storage medium including a number of modules, each module consisting of a combination of hardware and computer code that cause the processor to cause the computer system to perform a particular task, the modules including: a business location receive module, the business location receive module receiving, using the network interface card, a number of participating business geolocations representing a number of businesses; a business time usage receive module, the business time usage module receiving a business time usage goal corresponding to one of the number of participating business geolocations, the business time usage goal indicating an amount of time a person would be at the one of the number of business geolocations to be considered a customer of the business; a business usage module, the business usage module obtaining geolocation data of the first user using the global positioning system communicatively-coupled to the first user's smart device and comparing the first user's geolocation data to the number of business locations to determine when the first user is at one of the number of business geolocations and monitoring the first user geolocation for the time usage goal for a particular geolocation; a reporting module, the reporting module reporting to a central computer a usage time at a participating business geolocation; a calendaring module, the calendaring module receiving, scheduling, and displaying scheduled events; a business receive module, receiving a number of business identifiers, each of the number of business identifiers identifying a participating business that schedules reservations using the computer system; a business availability receive module, receiving, for each of the number of participating business identifiers, a number of times for each of the number of participating businesses is allowing reservations to be scheduled using the computer system; and a pricing module, receiving a number of pricing options for each of the number of times for each of the number of participating businesses is allowing reservations to be scheduled using the computer system.

In some aspects, the techniques described herein relate to a computer system, wherein the business usage module further includes a loyalty reward module, the loyalty reward module providing rewards to the first user of a device for frequenting one of the number of participating business geolocations, the loyalty reward module sending a loyalty reward to the first smart device of the first user, and the business usage module further includes a loyalty discount module, the loyalty discount module providing rewards to a use of a device for frequenting one of the number of participating business geolocations.

In some aspects, the techniques described herein relate to a computer system, further includes a related business identifier module, the related business identifier module identifying related participating businesses based on proximity to the user, proximity to the current participating business, the category of the participating business, and the type of participating business.

In some aspects, the techniques described herein relate to a computer system, further including a revenue generation module, the revenue generation module calculating revenue generated for a participating business from the first user using the computer system.

In some aspects, the techniques described herein relate to a computer system, further including a time generation module, the time generation module calculating an amount of time the first user spends at a business using the smart device communicatively-coupled to the computer system.

In some aspects, the techniques described herein relate to a computer system, further including a preference receive module and a preference send module, the preferences receive module receiving using a computer input device, a number of preferences for the first user, and the preference send module sending the preferences to a server which are used by the computer system as a factor in determining which participating business geolocations and participating business promotional content that are sent by the computer system to the smart device of the user.

In some aspects, the techniques described herein relate to a computer system, further including: a user information tracking module, the user information tracking module storing usage information of each user, the information stored being information about coupons the first user has redeemed, participating businesses the first user has been a customer, and other information about the first user's behavior used to predict what business would appeal to the first user next, with the stored information being identified to the user the information was obtained from with a unique identifier; a stored groupings module, the stored groupings module receiving information from the user information tracking module, storing groupings including participating businesses and the associated locations of these participating businesses stored as a list in the time order that they were visited by one of a plurality of users, with consecutive participating businesses in the grouping list, which is time ordered, being in different categories, with all businesses in the grouping being visited by a user within a time frame threshold; a pairing module, the pairing module evaluating a grouping of participating businesses and assigning an identifier signifying groupings that are better combinations to present to users, groupings that are worse combinations to present to users, and an identifier to rank groupings on a spectrum between the best and the worst groupings; a smart suggestions module, the smart suggestions module receiving information from the user information tracking module about the plurality of users and the participating businesses each user has participated in them, further using this information to suggest participating businesses to be retrieved by the business location receive module and sent to the smart device of the first user that the first user has not visited based on participating businesses other users have visited; a customer review module, the customer review module allowing users to create reviews for products or services of a participating business, the customer review module also only allowing a user to create a review when the business usage module determines that the user has been at the business long enough to meet the business time usage goal; a selection time threshold module, the selection time threshold module containing a time range that users must all indicate interest in an activity from a participating business in order to be grouped together for that activity; a friend threshold module, the friend threshold module containing a friend threshold for each activity from a participating business, the friend threshold defining the number of friends connected to a user who must also indicate interest in an activity in order for the computer system to group them together for that activity; and a friend module, the friend module containing information about which users are connected as friends, also allowing users to add new friends, look up others by an identifier, and accept friend requests; and, a selection module.

In some aspects, the techniques described herein relate to a computer system in claim 7, wherein the selection module displays content received from the business objective module with the selection module allowing the first user and the at least one friend of the first user to communicatively indicate which content received from the business objective module matches preferences of the first user and the at least one friend of the first user.

In some aspects, the techniques described herein relate to a computer system in claim 14, wherein the selection module communicates with the friend module when the first user indicates interest to determine which of the at least one friends of the first user who have also indicating interest, further communicating with the selection time threshold module to determine when the timeframe between indications of interest meets the selection time threshold, and communicates with the friend threshold module to determine when a number of the at least one friends of the user who have also indicated interest fulfills the friend threshold.

In some aspects, the techniques described herein relate to a computer system in claim 15, wherein when the friend threshold and the selection time threshold have been fulfilled for the first user and at least one friend of the first user, the selection module allowing the at least one friend of the first user to view a data visualization representing which of the at least one friend of the first user indicated interest in a participating business.

In some aspects, the techniques described herein relate to a computer system in claim 15, wherein when the friend threshold and selection time threshold are fulfilled for the first user and the at least one friend of the first user, a coupon associated with the activity or participating business for which the first user and the at least one friend of the first user indicated interest is sent by the computer system to the first user, via the smart device of the first user, and the at least one friend, via at least one smart device associated with the at least one friend.

In some aspects, the techniques described herein relate to a computer system in claim 7, wherein the pairing module further includes a time range score submodule, a distance score submodule, a unique users score submodule, and a final scores submodule.

In some aspects, the techniques described herein relate to a computer system in claim 18, wherein the final scores submodule adds up the scores from the time range score submodule, the distance score submodule, and the unique users scores submodule to create a final score for the pairing module to assign to a corresponding grouping, wherein the time range score submodule evaluates the average time range of a grouping, which is the average time between when the business in the grouping was visited to when the last business in the grouping was visited, further determining a score to identify groupings with a high time range, groupings with a low time range, and groupings on spectrum between the highest and lowest time ranges, wherein the distance score submodule evaluates the total distance a user must travel between all the businesses in the grouping, further assigning a score to a grouping which identifies groupings with a high total distance, groupings with a low total distance, and groupings on the gradient between the highest and lowest total distances, and when the unique users score submodule evaluates the total number of unique users who have visited the combination of participating businesses found in a grouping, further assigning a score to a grouping which identifies groupings which have a high number of unique users, groupings which have a low number of unique users, and groupings on the gradient between the highest and lowest number of unique users.

In some aspects, the techniques described herein relate to [PTO1] A method for monitoring business usage including providing a computer system, the computer system including a processor; a network interface card, communicatively connected to the processor; a time measurement system, the time measurement system communicatively connected to the processor; a non-transitory computer-readable storage medium, the non-transitory computer-readable storage medium including a number of modules, each module consisting of a combination of hardware and computer code that cause the processor to cause the computer system to perform a particular task, the modules including: a business location receive module, the business location receive module receiving, using the network interface, a plurality of business identifiers wherein each business identifier corresponds to a business entity of a plurality of business entities, and a plurality of sets of global positioning system coordinates wherein each set of global positioning system coordinates corresponds to one of the plurality of business identifiers; a business time usage module, the business time usage module receiving a plurality of business time usage goals wherein each of the plurality of business time usage goals corresponds to one of the plurality of business identifiers; a business usage module, the business usage module determining whether a first user was physically proximate to the one of the plurality of business entities for at least a length of time equal to or greater than the business time usage goal corresponding to the one of the business entities, wherein after the business usage module has determined that the first user was physically proximate to the one of the plurality of business entities for at least a length of time equal to or greater than the business time usage goal corresponding to the one of the business entities, then the business usage module stores, in the business usage module, a designation of customer status of the one of the business entities for the first user and instructs a customer review module to send a request to the first user requesting that the first user provide customer feedback to the computer system about the one of the business entities; determining that the first user was physically proximate to the one of the plurality of business entities for at least a length of time equal to or greater than the business time usage goal corresponding to one of the plurality of business identifiers that corresponds to the one of the plurality of business entities; and sending a request to the first user requesting that the first user provide customer feedback to the computer system about the one of the business entities.

A computer system for monitoring business usage, the computer system comprising: a central processing unit, a network interface card, a time measurement device, a server, a processor, and a non-transitory storage medium. The processor is communicatively connected to the network interface card. The time measurement system is communicatively connected to the processor. The network interface card is communicatively connected to users through smart devices controlled by the user. The non-transitory computer-readable storage medium includes a number of modules, each module is a portion of the non-transitory storage medium storing a specific set of instructions. Each module consists of a combination of hardware and computer code that causes the processor to cause the computer system to perform a particular task. The modules may include a business location receive module, a business time usage goal receive module, a business usage module, a reporting module, a business receive module, a business availability receive module, a pricing module, a pricing receive module, a revenue generation module, an off-hours business usage module, and a business objective module. The business 1 The business time usage module goal corresponds to one of the number of business geolocations, receives a business time usage goal, the business time usage goal indicates an amount of time a person would be at the one of the number of business geolocations to be considered a user of the business. The business usage module determines whether the user is physically proximate to a certain one of the business entities for at least a length of time equal to or greater than the business time usage goal corresponding to the business. A user is physically proximate if they are within the permissible distance from the geolocation coordinate of the business or the geolocation area of the business. Permissible distance refers to a specified range of distance, which in preferred embodiments is 10 feet. The business usage module communicates with a user smart device to receive the user geolocation data from the smart device, which uses a global positioning system to obtain the geolocation coordinates of the smart device across time. The business usage module compares the user geolocation coordinates to the number of business locations to determine when the person is at one of the number of business geolocations and monitors the user geolocation data for comparing the user time physically proximate to the business with the time usage goal for the particular geolocation coordinate of the business. The reporting module reports usage time of a user at a business geolocation to the computer system.

A computer system for monitoring business usage, the computer system includes a processor, a network interface card, a global positioning system, a user display, a time measurement system, and a non-transitory computer-readable storage medium. The Processor is communicatively connected to the network interface card, the global positioning system, the user display, the time measurement system, and the non-transitory computer-readable storage medium. The non-transitory computer-readable storage medium includes a number of modules, each module includes a combination of hardware and computer code that causes the processor to cause the computer system to perform a particular task. The modules include a business location receive module, a business time usage goal receive module, a business usage module, a reporting module, a calendaring module, a business availability receive module, and a pricing module. The business location receive module receives, using the network interface card, a number of business geolocations that represent a number of businesses. The business time usage module goal corresponds to one of the number of business geolocations, receiving a business time usage goal, the business time usage goal indicating an amount of time a person would be at the one of the number of business geolocations to be considered a user of the business. The business usage module obtains a user geolocation using the global positioning system and compares it to the number of business locations to determine when the person is at one of the number of business geolocations and monitoring the user geolocation for the time usage goal for a particular geolocation, the reporting module reports to a central computer a usage time at a business geolocation, the calendaring module receiving, scheduling, and displaying scheduled events, receives a number of business identifiers, each of the number of business identifiers identifying a business that schedules reservations using the computer system, receives, for each of the number of business identifiers, a number of times for each of the number of business is allowing reservations to be scheduled using the computer system, and, receives number of pricing options for each of the number of number of times for each of the number of business is allowing reservations to be scheduled using the computer system.

The computer system also contains a user information tracking module, a stored groupings module, a pairing module, a smart suggestions module, a customer review module, a swipe threshold module, a friend threshold module, a friend module, and a swipe module.

The user information tracking module stores information about which businesses all the users using the computer system visit. The stored groupings module stores a plurality of these groupings. The stored groupings module, in the preferred embodiments, only storing groupings where the first and the second consecutive businesses are not from the same category. The pairing module assigns a score to each grouping based on the time between when the first and last business in the grouping was visited, the total distance needed to travel between the business in the grouping, and the number of unique users who have visited the same combination of businesses in the grouping. The smart suggestions module also receives information from the user information tracking module to predict what a business that a user would be most likely to visit based on the user's previous behavior and the choices of other users with similar behavior patterns. The information from the smart suggestions module and the pairing module is used to determine which business locations are presented to a user.

The customer review module interacts with the business usage module to determine when a user has been at a business long enough to be considered a customer or someone who can give an adequate review. The amount of time that a user must be at a business to be considered a customer is set by the business. This time information received from a business may be received through the business objective module (430-16). When the user has been at a business location greater than or equal to time chosen by the business, the customer review module allows the user to create a review for the corresponding business.

The friend module allows users to search and add friends. The swipe module is used to target coupons for groups of interested friends or encourage friends to visit businesses with their friends. The swipe module presents possible activities to a user and allows the user to indicate which ones they are interested in. In this embodiment, indicating interest is equivalent to swiping up on the user display. The selection time threshold module determines a time frame that a user's friends must also swipe within to be grouped together. The friend threshold module determines a minimum number of friends of a user who must also indicate interest to be grouped. If a group of users meets these thresholds, content from the business objective module such as a coupon or promotions is made available to all the users in the group.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, subcomponents, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph six, interpretation for that unit/circuit/component.

A subcomponent includes a processor and a number of instructions that cause the subcomponent to perform a task. A number of sub-components may share a processor, varying the subcomponent based on the number of instructions executed by a processor.

### BRIEF DESCRIPTION OF THE DRAWINGS

In order to describe the manner in which the above-recited and other advantages and features can be obtained, a more particular description will be rendered by reference to specific implementations thereof, which are illustrated in the appended drawings. These drawings depict only some implementations; the invention is not limited solely to what is depicted in the drawings; implementations will be described and explained with additional specificity and detail through the use of the accompanying drawings in which:

FIG. 1 illustrates an example of a computer system for monitoring a user's usage of a business.

FIG. 2 illustrates an example of a computer system for monitoring a user's usage of a business communicatively-connected to the smart device of a user among a number of businesses.

FIG. 3 illustrates an example of a computer system for monitoring business usage and modules it may contain.

FIG. 4A illustrates an example of a computer system for monitoring business usage and modules it may contain.

FIG. 4B illustrates an example of modules of the computer system for pairing activities into groupings and evaluating which groupings are the most desirable to present to users.

FIG. 4C illustrates an example of the modules used by an exemplary computer system for monitoring business usage which only allow a user to provide reviews of a business when the computer system has determined that the user has physically been near the business for a certain minimum threshold of time.

FIG. 5A illustrates an example of modules that may be of the computer system to allow the computer system to determine when to display a coupon to a group of friends, and illustrates the modules that this module interacts with.

FIG. 5B illustrates an example of how the computer system with the modules described in FIG. 5A works with multiple users.

FIG. 6 illustrates an example of all modules described in FIGS. 4A, 4B, 4C, 4D and 5A.

FIG. 7 illustrates an example of scheduling activities using the computer system.

FIG. 8 illustrates an example of calendaring activities using the computer system.

FIG. 9 illustrates an example of a user interface for display on a smart device for group selection.

FIG. 10 illustrates an example of user interfaces for display on a smart device.

FIG. 11 illustrates an example of user interfaces for display on a smart device.

FIG. 12 illustrates an example of user interface for users to select group participation using a smart device.

FIG. 13 illustrates an example of a user interface for inviting a number of friends to a group activity.

FIG. 14 illustrates an example of user interfaces for display on a smart device using messages to coordinate an activity using the computer system.

FIG. 15 illustrates an example of user interfaces, for displaying on a smart device, selections associated with a user using the computer system.

FIG. 16 illustrates an example of user interfaces, for displaying on a smart device, selections associated with a user using the computer system.

FIG. 17 illustrates an example of user interfaces, for displaying on a smart device, for configuring a user profile using the computer system.

### DETAILED DESCRIPTION

A detailed description of the claimed invention is provided below by example, with reference to examples in the appended figures. Those of skill in the art will recognize that the components and steps of the invention as described by example in the figures below could be arranged and designed in a wide variety of different configurations, without departing from the substance of the claimed invention. Thus, the detailed description of the examples in the figures is merely representative of a number of embodiments of the invention and is not intended to limit the scope of the invention as claimed.

In some instances, numerical values are used to describe features such as spreading factors, angle, trajectory, and distances. Though precise numbers are used, one skilled in the art recognizes that small variations in the precisely stated values do not substantially alter the function of the feature being described. In some cases, a variation of up to 50% of the stated value does not alter the function of the feature. Thus, unless otherwise stated, precisely stated values should be read as the stated number, plus or minus a standard variation common and acceptable in the art.

For purposes of this disclosure, “displaying” means instructing the device to show data in a manner that can be perceived by humans.

For purposes of this disclosure, local area message exchanger refers to a system for exchanging a number of local area messages.

For purposes of this disclosure, a subcomponent refers to a combination of hardware and program instructions for performing a designated function. Each of the subcomponents may include a processor and memory. The program instructions may be stored in the memory and may cause the processor to execute the designated function of the subcomponents. Additionally, a smartphone app and a corresponding computer system may be used to implement a subcomponent or a combination of subcomponents. For the purposes of this disclosure, a smart device app is defined as information or computer software code that a user downloads onto the non-transitory storage medium on their smart device and the downloaded information or computer software code allows the user to communicate to the computer system. Additionally, a video device comprising a computer system or system as described in the claims may be used to implement a subcomponent or a combination of subcomponents. Additionally, a video device comprising a computer system or system as described in the claims may be used to implement a subcomponent or a combination of subcomponents. Additionally, a video device and a computer system or a system may be used to implement a subcomponent or a combination of subcomponents.

Examples extend to apparatus, devices, methods, systems, and computer program products for exchanging a number of local area messages. The present invention generally relates to systems and methods for exchanging messages between devices through a local area message exchanger. More specifically, the disclosed system relates to exchanging a number of local area messages between a number of users to facilitate the use of services that are available or that are made available.

As used in the present specification and in the appended claims, local area message refers to a message sent from one device to another device on a network defined by a limited geographic area, such as within a ten miles radius, within a fifty miles radius, within a one-hundred-mile radius, or within another geographic area. An example of a local area message would be an invitation to dinner for all devices on the network.

As used in the present specification and in the appended claims, subcomponent refers to a combination of software and hardware that performs a particular task.

As used in the present specification and in the appended claims, video device refers to a computer that provides a video or replicated video interface to a user of the video device allowing the user to see images, videos, graphics, and text. A video device may include an input device such as a touch screen, allowing input that includes text input or drag-and-drop of images.

As used in the present specification and the appended claims, services refer to services or products that may be desired or requested by users of the system. A calendar as used in the present specification refers to a chart or graphical representation showing a number of days, weeks, and months of a particular year.

As used herein an “event” refers to a planned public, a social occasion, or a private activity that can be scheduled on a calendar. Such scheduling may include a time, a place, a name and other participants.

As used herein an “a business” refers to a location or service offered in the course of commerce. A business may include a physical location or may provide a service at a customer location or a public location.

As used herein the term “participating business” refers to a business that is making use of the computer system defined herein.

As used herein the term “non-participating business” refers to any business that is not making use of the computer system defined herein.

As used herein a global positioning system refers to any system that determines a location on the planet earth. This may include the use of satellites, cell phone towers, or wireless communication through computer routers in known locations. It also includes the hardware and software components that allow devices to use the system.

As used herein time refers to a period of progress of existence and events in the past, present, and future regarded as a whole.

As used herein time usage refers to a period of time that is spent with an activity or location.

As used herein, calendaring refers to the office of scheduling and recording an activity on a calendar.

As used herein revenue refers to income, especially when a company or organization receives monetary compensation for a product or service. Revenue may include expressions of income, expenses, or profit.

As used herein user preferences refers to either entered or implied preferences of a user of a device or an account. Such preferences may be entered by a user or may be derived based on a history of activity of the user.

As used herein customer refers to a user who has completed a transaction with a business such as compensating the business for products and/or services received from the business.

As used herein, off-hours refers to time intervals within a business's customer service hours during which there is a notable reduction in customer traffic, transaction volume, which may result in a decreased workload or operational pace compared to peak hours for the business. Off hours may be determined by the business having less than 100% of the average rate of a certain metric such as physical transactions per hour, but in preferred embodiments is determined by having 75% or less than the certain metric. In other embodiments the metric may instead be revenue per hour, customer activity per hour, or customer traffic per hour.

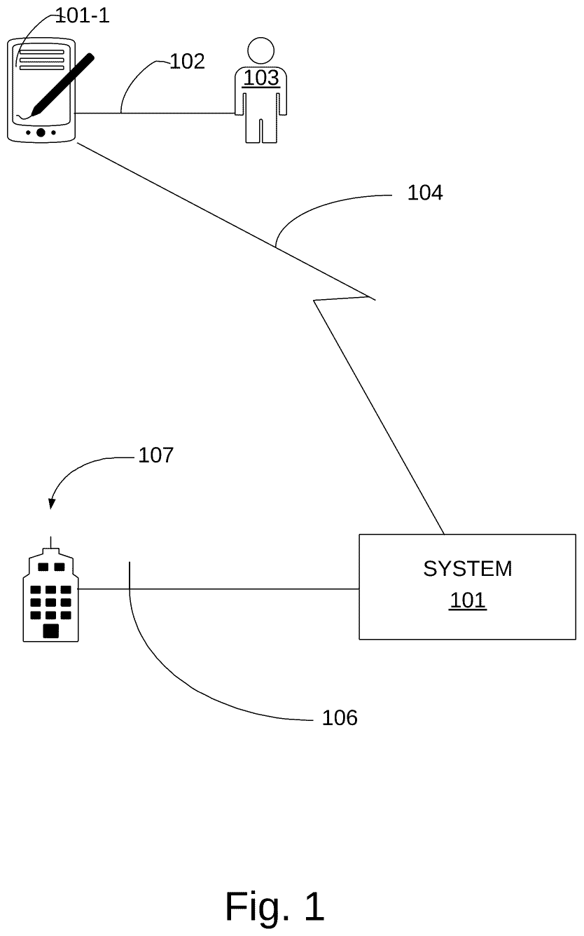

FIG. 1 illustrates an example of using a computer system for monitoring business usage. A user (103) communicates (102) with a smart device which communicates (104) with a computer system (101) for monitoring business usage. The communication (104)/(106) may be done wirelessly, such as through a wireless local area network, or a telephonic communication network. The computer system (101) may communicate (106) with a business (107) in methods similar to how it communicates with the smart device (101-1). The server (105) may facilitate communication between the computer system (101) and the business (107).

An embodiment of a computer system (101) is disclosed. Computer system (101) wirelessly communicates with a first smart device (101-1) of a user (103), and the first smart device (101-1) wirelessly communicates with the computer system (101); the wireless communication may be direct or indirect. The user (103) may communicate with the first smart device (101)-1; non-limiting examples of the types of communication (102) may be via voice commands, via haptic communication such as by a pointing device such as a mouse or stylus, or keyboard. The communication (102) signals to a first user via a first smart device (101-1) of an event that the user (103) plans on attending. The smart device (101-1) schedules the activity on a calendar. The smart device communicates (104) the planned activity to the computer system (101). The computer system (101) may monitor planned activities for a number of different users. The computer system (101) communicates (106) the planned activity to a participating business (107) associated with the planned activity. For example, if the user (103) is planning on eating dinner at a restaurant at a specified time the server (105) communicates to the restaurant the user's intent on dining there.

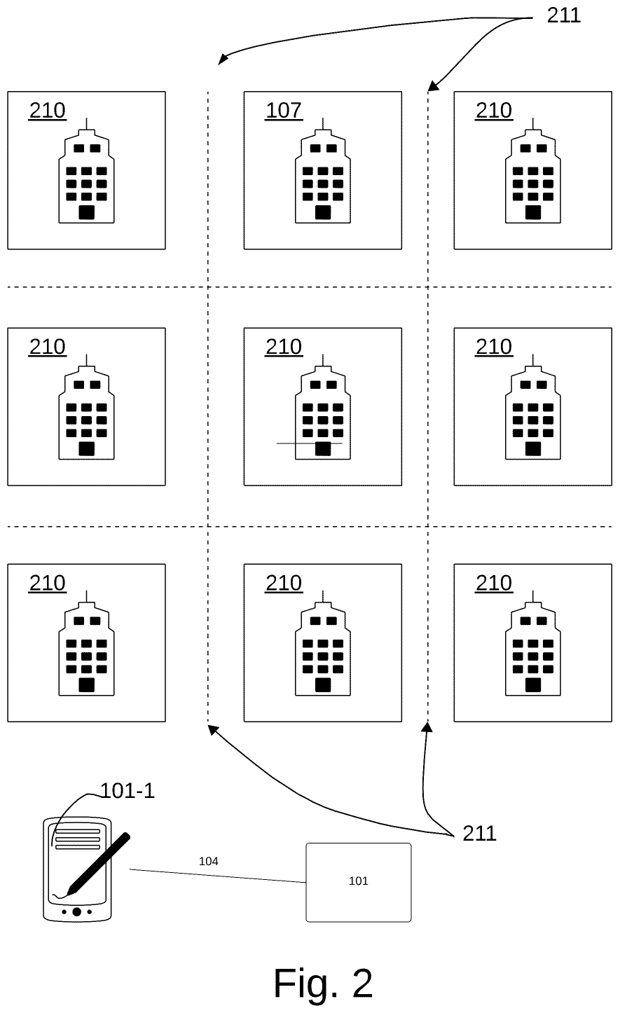

FIG. 2 illustrates an example of a computer system (101) for monitoring a user's usage of a business among a number of businesses. The computer system (101) may store data on a number of businesses each in a geolocation area. A number of participating businesses (107) may communicate with a system (101). Non-participating businesses (210) may not communicate with the computer system (101). Each of the number of businesses (107, 210) may be connected by a number of paths (211) which may be one such as a road or a walkway. The paths (211) allow individuals to move between businesses using a car, bicycle, walking, or other means of motion. The total distance of the path from one business to another may be stored on the non-transitory storage medium (425) of the computer system and may be used to determine the distance between businesses.

The smart device (101-1) provides a geolocation indicating where in an area the device is located. It may be assumed that the user (FIG. 1, 103) is at the same geolocation as the smart device (101-1). When the user (FIG. 1, 103) is physically proximate to a participating business (107) the computer system (101) may be communicatively-coupled to the smart device (101-1) and may measure the amount of time the smart device (101-1) is within a geographic radius of the participating business (107). In preferred embodiments, physically proximate is within 10 feet of a boundary of a location. The area contained within the boundary of a location refers to the geographic area that is considered to be part of the business. In some embodiments, the computer system (101) may store information about WIFI networks of a business and then determine that a user is physically proximate to the business when a user's smart device (101-1) is accessing a number of WIFI networks of a business location. Alternatively, the computer system (101) may receive the amount of time the smart device (101-1) is within a geographic radius of the participating business (107). The more time a smart device (101-1) is physically located near a participating business (107) indicates that a user (FIG. 1, 103) is more likely to be using the services provided by a participating business (107) and the user is considered to be using the services when their geolocation is near the participating business. When a user (FIG. 1, 103) spends a minimum amount of time at the participating business (107), computer system (101) may determine that the user (FIG. 1, 103) has done business with the participating business (107.

An overall example according to FIG. 2 will now be given. In some embodiments, the computer system (101) communicates with a smart device (101-1) controlled by a user. The smart device (101-1) may travel with the user around a geographic area such as a city, town, or shopping area. A number of participating businesses (107) and non-participating businesses (210) may be in the area connected by a number of paths (211); an example of a path is a road or street. The paths (211) connect the businesses so that individuals may travel between or to a particular business. In this embodiment of the computer system (101), the computer system (101) communicates with a first smart device (101-1) as a user travels with the smart device (101-1) to a participating business (107). The global positioning unit of the smart device, comprising global positioning system-enabled hardware components and global positioning system-enabled modules, in the smart device (101) determines that the smart device is at the participating business (107). The computer system (101) communicatively-coupled (104) to the smart device (101-1) receives this geographic location information and calculates the amount of time that the smart device remains at the business partner (107) or receives the amount of time, from the smart device, that the smart device remains at the participating business. The amount of time that the smart device (101) is at the participating business (107) may be a measured metric or data set stored on computer system (101), and computer system (101) may process the measured metric or data set using a number of algorithms to generate data that is presented by the computer system (101) to a number of participating businesses (107) for display on a computer or device associated with the number of participating businesses (107). This is described in later figures.

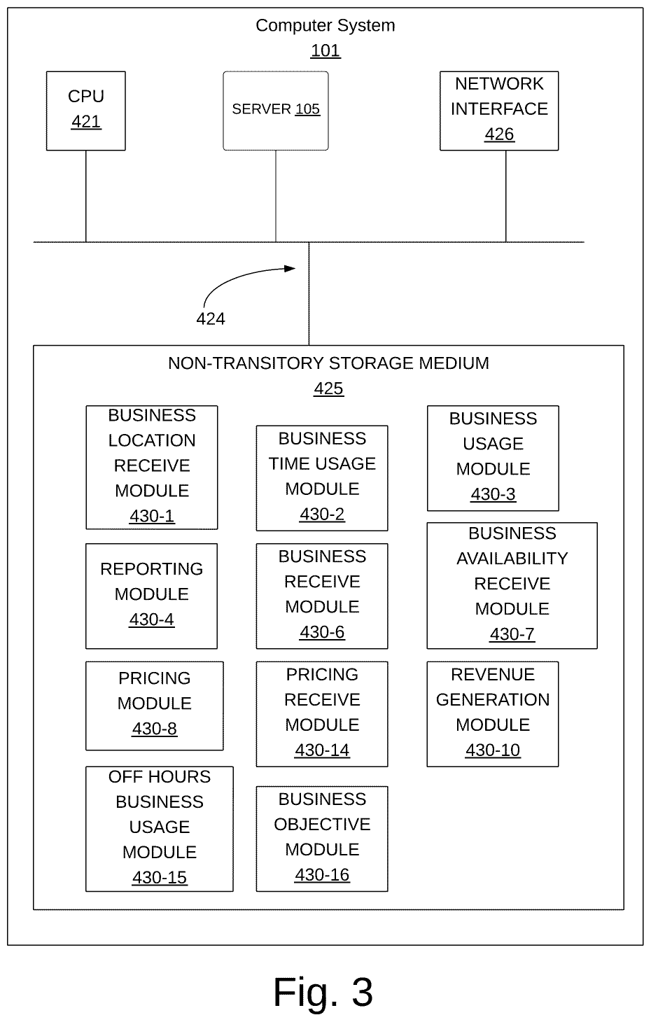

FIG. 3 illustrates an example of a computer system for monitoring business usage. The computer system (101) for monitoring business usage may include a central processing unit (421), a server (105), a network interface (426), a communication bus (424) and a non-transitory storage medium (425).

The non-transitory storage medium (425) contains a number of modules (430). In preferred embodiments the module is a portion of the non-transitory storage medium storing a specific set of instructions, wherein the non-transitory storage medium is communicatively-coupled to a processor (424). The modules (430) are identified by the task that they primarily perform, however, modules may be combined to accomplish another task or combined to accomplish the task of any single module.

These modules (430) include a business location receive module (430-1), a business time usage module (430-2), a business usage module (430-3), a reporting module (430-4), a business receive module (430-6), a business availability receive module (430-7), a pricing module (430-8), a pricing receive module (430-14), a revenue generation module (430-10), an off-hours business usage module (430-15), and a business objective module (330-16).

The business location receive module (430-1) receives, using the network interface (426), a number of participating businesses and their locations (FIG. 1, 107). The number of participating businesses (FIG. 1, 107) participate in a program whereby the computer system (101) may schedule users to use the participating business (FIG. 1, 107). The computer system (101) may facilitate the usage of participating businesses (FIG. 1, 107) without causing a large number of customers that may delay or lower the quality of service at the participating business (FIG. 1, 107). The computer system (101) may facilitate a new business acquiring new customers to gain a reputation and exposure into a community. The computer system (101) may be used to drive customers or clients to a participating business (FIG. 1, 107) during off-hours to improve the profitability of the business.

The business time usage module (430-2) of the computer system (101) may monitor the amount of time the smart device (101-1) is geographically located in the proximity of a participating business (FIG. 1, 107), using geolocation information received from the global positioning system of the smart device (101-1) when the smart device (101-1) is communicatively-coupled to the computer system (101) through the network interface (426). Measuring an amount of time that the smart device (101-1) spends at a business may allow correlation as to the nature of the usage of the participating business (FIG. 1, 107) by a user (FIG. 1, 103). As a result, different businesses will have different time thresholds before the computer system (101) will determine that a user (FIG. 1, 103) has been a customer of the business. For example, a short business usage time may indicate that the business was used for a take-out service, and a take-out service will have a short business usage time. If the business does not offer a take-out service, a short business usage time may indicate that the user (FIG. 1, 103) arrived at the business and for some reason decided not to solicit the business. For example, a sit-down restaurant would have a longer threshold time than the take-out service, and a business offering take-out and sit-down options could have variable threshold times depending on which service a customer participates in. A number of customers arriving at the business and not participating in the services offered by the business may indicate that the advertising does not correspond to the nature of the business or that the business itself does not present well to customers. This information is stored by the business usage module (430-3) and may be communicated to the corresponding participating business (FIG. 1, 107) through the network interface (426) of the computer system (101).

The computer system (101) may include a business usage module (430-3). Tracking the usage of a business by the business usage module (430-3) may include referencing information obtained by the business time usage module (430-2). The business usage module (430-3) may also not reference the business time usage module (430-2). The business usage module (430-3) may acquire data from the smart device (101-1) of a user (FIG. 1, 103) or from a participating business (107) as to items purchased, deals used, coupons, or other ways of measuring how the business is being used to provide the participating business (FIG. 1, 107) with feedback as to the effectiveness of the participating business (FIG. 1, 107) and its products or services.

A reporting module (430-4) may report data to the server (105) or directly to a participating business (FIG. 1, 107) through the network interface (426). The reporting module (430-4) may report data related to the smart device (101-1) behavior around a participating business (FIG. 1, 107) or the usage of a business by a user controlling the smart device (101-1). The reporting module (430-4) may allow the server (105) to track a number of users (FIG. 1, 103) and their interaction with a number of participating businesses (FIG. 1, 107).

A business receive module (430-6) may allow the computer system (101) to receive data about a number of participating businesses (FIG. 1, 107) that have elected to receive from the computer system (101) the benefits of a participating business, such as being scheduled for customer visits, receiving communications, or sending communications. The business receive module (430-6) may receive a number of business metadata from a server (FIG. 1, 105). The information received may include coupons and promotions from participating businesses (FIG. 1, 107) to be displayed on a number of smart devices associated with a number of users.

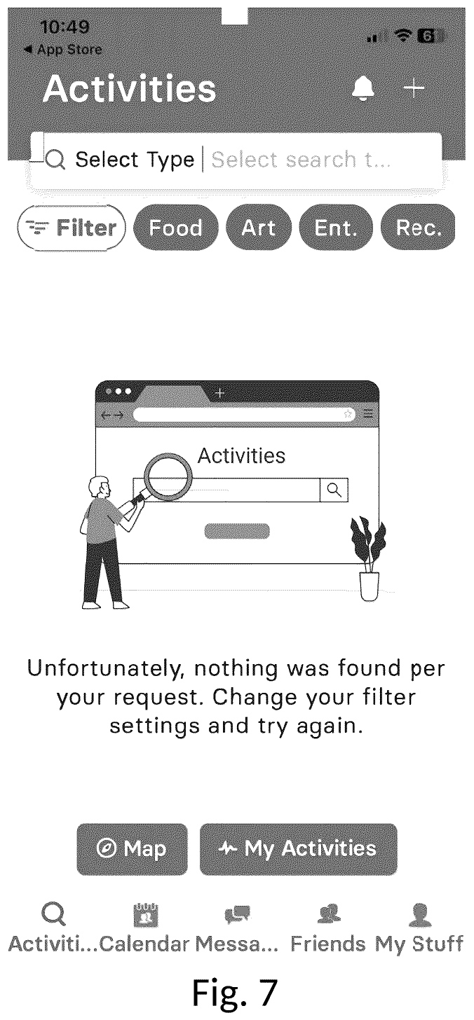

A business availability receive module (430-7) may allow the computer system (101) to receive from a participating business (FIG. 1, 107) a list of times that a participating business (FIG. 1, 107) is available for scheduling. The times a participating business (FIG. 1, 107) is available for scheduling may be related to business hours. The times a participating business (FIG. 1, 107) is available for scheduling may be related to anticipated traffic for said business. For example, a participating business (FIG. 7, 107) expecting a large number of customers at a particular time may indicate that the participating business (FIG. 1, 107) is available for scheduling during their busy times.

A Pricing Module (430-8) may allow the computer system (101) to receive pricing through the network interface (426) from a participating business (FIG. 1, 107) for the participating business (FIG. 1, 107) that the participating business (FIG. 1, 107) would like to communicate to potential customers or clients. The pricing module (430-8) may receive a number of special pricing offers for low traffic time periods to increase the businesses overall utilization.

A pricing receive module (430-14) may receive pricing data from a server (FIG. 1, 105).

A revenue generation module (430-10) may calculate the amount of revenue generated for a business by a single user (FIG. 1, 103), which may have an account that is accessed by a number of smart devices. The revenue generation module (430-10) may calculate or estimate gross revenue or net revenue attributable to a group of a number of users that have communicated with the computer system (101), the number or amount of special offers offered to users via computer system (101), or profits for a participating business attributable to users of the computer system (101).

An off-hours business usage module (430-15) may identify usage of a participating business (FIG. 1, 107) during non-peak hours. An off-hours business usage module may allow a user (FIG. 1, 103) to save money or time during off-hours and may increase the overall usage of a participating business (FIG. 1, 107) during off-hours.

A business objective module (430-16) may indicate a business objective to help communicate and determine times, prices, coupons, offers, or specials to a user of the computer system (101), accessing the computer system (101 to help the business achieve its objective. The business objective module (430-16) may include settings which can be modified by the participating business (FIG. 1, 107) and receive business objective information from the participating business (FIG. 1, 107). The information given by the business objective module (430-16) may be used to determine when and to which users (FIG. 1, 103), these times, prices, coupons, offers, or specials are communicated to.

An overall example according to FIG. 3 will now be given. FIG. 3 is a diagram of some embodiments of the computer system (101). The computer system (101) includes a CPU (421), a network interface (426), a server (105), a communication bus (424), and a non-transitory storage medium (425). The non-transitory storage medium (425) includes a number of modules (430). The computer system (101) uses the business location receive module (430-1) to receive a business location of a participating business (FIG. 1, 107). The business location may include geographic location that can be compared with information from the global positioning system of the smart device (101-1). Computer system (101) may receive a number of business locations; computer system (101) may also send a number of business locations to a number of smart devices (101-1, 101-2, 101-3, 101-4, 101-5). The business location may include a precise geolocation coordinate as well as a permissible distance from that geolocation coordinate to be considered at a business partner location.

The computer system (101) may use a business time usage module (430-2) to determine how long the smart device (101-1) of a specific user is at a participating business (FIG. 1, 107). In this example the business time usage module (430-2) determines how long the smart device (101-1) of an associated user is at the participating business (FIG. 1,107).

The business usage module (430-3) may compare data about how long a user (FIG. 1, 103) was at a business, which is contained in the business time usage module (430-2), with other data associated with the participating business (FIG. 1, 107). Such data may include the categorical nature of the business to determine which category the participating business (FIG. 1, 107) belongs in, expected time that a customer may remain at the business to help determine the threshold time before a user is considered a customer, or information regarding offers of goods or services made by the business's previous behavior and the choices of other users with similar behavior patterns.

The reporting module (430-4) may report to a participating business (FIG. 1, 107) through the network interface (426) or the server 105) a user's (FIG. 1, 103) usage based on the information from the business usage module (430-3).

The business receive module (430-6) may receive information regarding a number of participating businesses (FIG. 1, 107) that the user (FIG. 1, 103) of the smart device (101-1) may be interested in. The information received may include information such as the number of businesses, user preferences, business availability, historic use, or demographic information. The business receive module (430-6) may also receive the geolocation of said participating businesses (FIG. 1, 107). The business availability receive module (430-7) receives a number of times the participating businesses (FIG. 1, 107) received by the business receive module (430-6) are soliciting customers. The availability may be based on when the participating business (FIG. 1, 107) is open, when the participating business (FIG. 1, 107) has adequate staffing, or other information the participating business (FIG. 1, 107) may have regarding when and how the participating business (107) wishes to solicit customers.

The pricing module (430-8) may receive prices or a price range for goods and services of a business from the participating business (FIG. 1, 107). The pricing module (430-8) may consider historic customer usage.

The pricing receive module (430-14) may receive from a server (FIG. 1, 105) a number of service or product offers that are available to a user (FIG. 1, 103). This may include the price offered to a user (FIG. 1, 103) at a participating business (FIG. 1, 107) location at a given time.

The revenue generation module (430-10) may calculate an amount of revenue generated for a participating business (FIG. 1, 107) based on the user's (FIG. 1, 103) usage of the computer system (101). The revenue module may communicate the revenue generated to a central server (FIG. 1, 105) for calculation and tabulation for participating businesses (FIG. 1, 107).

The off-hours business usage module (430-15) may calculate usage by customers of a business partner (FIG. 1, 107) during non-peak business hours. For example, a restaurant who is a participating business (FIG. 1, 107) expects to have extra business around mealtimes. A participating business (FIG. 1, 107) may use the computer system (101) to drive business during non-mealtimes.

The business objective module (430-16) may receive information regarding a participating business (FIG. 1, 107) and the business objectives it has in communication with the computer system (101). The business objective contains information from the business that may be used to determine which offers, specials, discounts, or other deals are presented to a user of the computer system (101) to assist the Participating Business (FIG. 1, 107) in obtaining its objective.

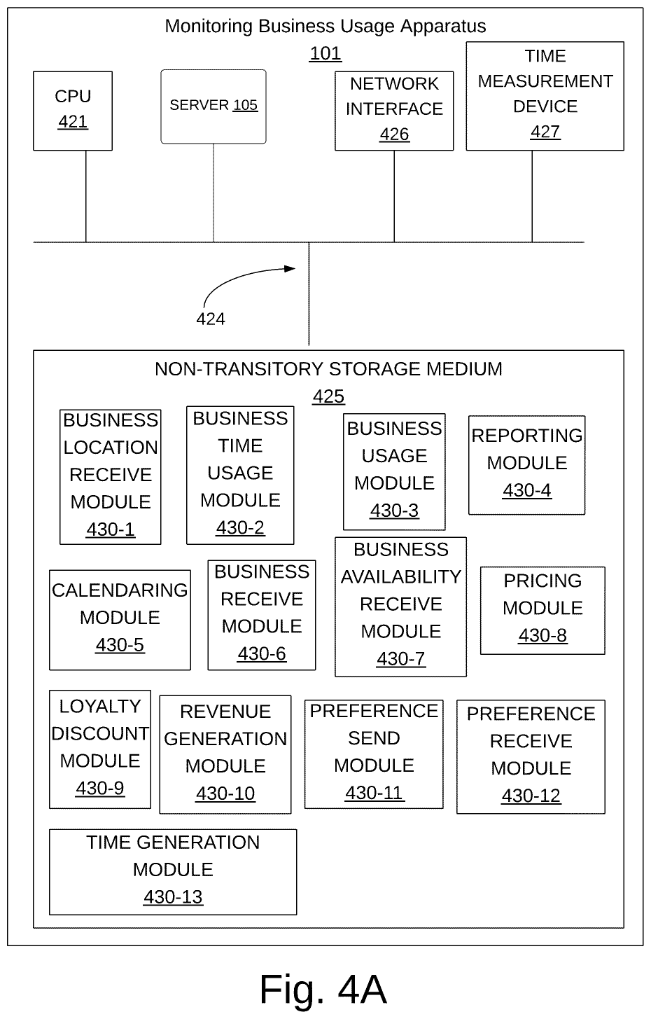

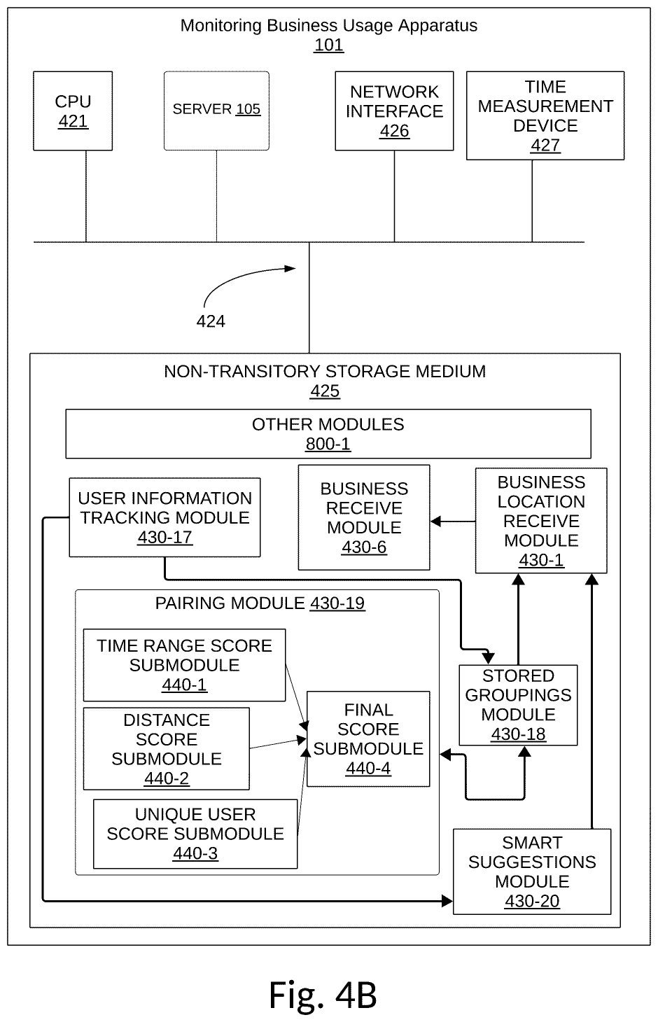

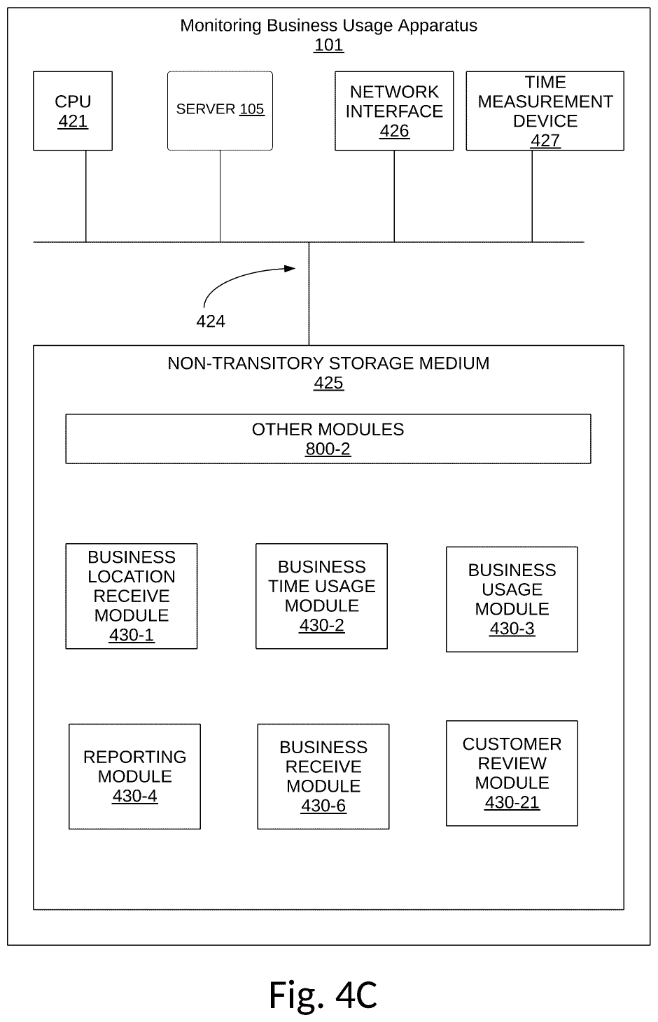

FIG. 4A illustrates another embodiment of the computer system (101) that tracks the usage of a participating business (FIG. 1, 107). The computer system (101) includes a processor (421), a Network Interface (426), a Time Measurement device (427), and a non-transitory storage medium connected by a communication bus (424).

The non-transitory storage medium includes a Business Location Receive Module (430-1), a Business Time Usage Module (430-2), a Business Usage Module (430-3), a Reporting Module (430-4), a Calendaring Module (430-5), Business Receive Module (430-6), a Business Availability Receive Module (430-7), a Pricing Module (430-8), a Loyalty Discount Module (430-9), a Revenue Generation Module (430-10), a Preference Send Module (430-11), a Preference Receive Module (430-12), and a Time Generation Module (430-13).

The business location receive module (430-1) receives, using the network interface card, a number of business geolocations representing a number of participating businesses (FIG. 1, 107).

The business time usage module (430-2) contains data, such as multiple business time usage goals corresponding to multiple participating business (FIG. 1, 107) geolocations. The business time usage goal for a particular business geolocation indicates an amount of time a user (FIG. 1, 103) would need to be at a particular business geolocation to be considered a customer of the business. The business time usage goal for each participating business which is contained in the business time usage module (430-2) may vary among different participating businesses (FIG. 1, 107). Each business time usage goal of the plurality of business time usage goals solely corresponds to a number of geolocation coordinates corresponding to one of the plurality of business entities, where each business time usage goal indicates a threshold time of a business entity for which a first smart device of a first user must be physically proximate to the business geolocation before the business time usage module considers the first user to be a customer of the business.

The business usage module (430-3) obtains a user (FIG. 1, 103) geolocation using the global positioning system (422) and compares the geolocation of the user to the number of participating business (FIG. 1, 107) locations to determine when the user (FIG. 1, 103) is at one of the number of participating business (FIG. 1, 107) geolocations and monitors the user (FIG. 1, 103) geolocation for the time usage goal contained in the business time usage module (430-2) for a particular geolocation.

The reporting module (430-4) reports to a central computer a usage time of a user (FIG. 1, 103) at a business geolocation or may report the same information directly to a participating business (FIG. 1, 107) through the network interface (427).

A calendaring module (430-5) is used for receiving, scheduling, and displaying scheduled events.

The business receive module (430-6) receives a number of business identifiers, each of the number of business identifiers identifies a participating business (FIG. 1, 107) that schedules reservations using the computer system (101).

The business availability receive module (430-7) receives for each of the number of business identifiers, a number of times for each of the number of participating businesses (FIG. 1, 107) allowing reservations to be scheduled using the computer system (FIG. 1). The pricing module (430-8) receives a number of pricing options for each of the number of times for each of the number of participating businesses (FIG. 1, 107) that is allowing reservations to be scheduled using the computer system (FIG. 1, 101). The loyalty discount module (430-9) provides rewards to a user (FIG. 1, 101) for frequenting one of the number of business geolocations. The revenue generation module (430-10) calculates revenue generated for a participating business (FIG. 1, 107) from a user (FIG. 1, 103) using the computer system (FIG. 1, 101). The preference send module (430-11) sends the preferences to a server (FIG. 1, 105) to influence the selections sent to the business receive module (430-6). The preference receive module (430-12) receives, using a computer input device, receives a number of preferences for a user (FIG. 1, 103). The time generation module (430-13) calculates time a user spends at a participating business (FIG. 1, 107) while using the smart device (FIG. 1, 101-1) communicatively-coupled to the computer system (101).

The business location receive module (430-1) receives, using the network interface (426), such as a network interface card, a number of business geolocations representing a number of participating businesses (FIG. 1, 107). The business location receive module (430-1) receives identification of a number of participating businesses (FIG. 1, 107), using the network interface (426), from which a user may select. The business location receive module (430-1) may receive businesses based on user preference or other factors in predicting which businesses a user may solicit.

The business time usage module (430-2) contains business time usage goals which each correspond to one of the number of participating business (FIG. 1, 107) geolocations. The business time usage goal indicates an amount of time a person must be at the corresponding participating business (FIG. 1, 107) geolocations to be considered a user of the business. The time a user spends at a participating business (FIG. 1, 107) may be compared to the expected usage of that business to determine when a user actually does business and may be used to measure the user satisfaction with the business.

The business usage module (430-3) obtains a user (FIG. 1, 103) geolocation data using the global positioning system of a smart device (101-1) and compares the geolocation data to the number of participating business (FIG. 1, 107) locations to determine when the user (FIG. 1, 103) is at one of the number of participating business geolocations (FIG. 1, 107) and monitors the user (FIG. 1, 103) geolocation for the time usage goal obtained from the business time usage module (430-2) for a particular geolocation.

The reporting module (430-4) reports to a central computer a usage time of a user (FIG. 1, 103) at a participating business (FIG. 1, 107) geolocation.

The calendaring module (430-5) receives, schedules, and displays scheduled events.

The business receive module (430-6) receives a number of business identifiers, each of the number of business identifiers identifies a participating business (FIG. 1, 107) that schedules reservations using the computer system (101).

The business availability receive module (430-7) receives for each of the number of business identifiers, a number of time ranges for each of the number of businesses that is allowing reservations to be scheduled using the computer system (101).

The pricing module (430-8) receives a number of pricing options for time ranges for which each of the number of businesses is allowing reservations to be scheduled using the computer system (101).

The loyalty discount module (430-9) provides rewards to a user (FIG. 1, 103) for frequenting one of the number of participating businesses (FIG. 1, 107).

The revenue generation module (430-10) calculates revenue generated for a participating business (FIG. 1, 107) from a user (FIG. 1, 103) using the computer system (101).

The preference send module (430-11) sends, using the network interface (426), a number of preferences from a user (FIG. 1, 103).

The preference receive module (430-12) receives, using a computer input device from the smart device of the user, a number of preferences for a user (FIG. 1, 103).

The time generation module (430-11) calculates time a user (FIG. 1, 103) spends at a participating business (FIG. 1, 107) using a smart device (101-1) communicatively-coupled with the computer system (101).

FIG. 4B illustrates another embodiment of the computer system (101) as depicted in FIG. 4A, but with additional modules. FIG. 4B illustrates how these additional modules allow the business location receive module (430-1) to receive businesses and send business locations to a user through their smart device based on factors in predicting which participating businesses (FIG. 1, 107) a user (FIG. 1, 103) may be more likely to solicit. The computer system (101) includes a processor (421), a Network Interface (426), a Time Measurement device (427), and a non-transitory storage medium (425) connected by a communication bus (424).

The non-transitory storage medium (425) includes Other Modules (800-1), a Stored Groupings Module (430-18), a User Information Tracking Module (430-17), a Pairing Module (430-19), a Business Receive Module (430-6), a Business Location Receive Module (430-1), and a Smart Suggestions Module (430-20).

Other Modules (800-1) represents the other modules in the Non-Transitory Storage Medium (425) represented in FIG. 4A that, for this embodiment, are not necessary to understand how the additional modules work.

The Pairing Module (430-19) includes a Time Range Score Submodule (440-1), a Distance Score Submodule (440-2), a Unique User Score Submodule (440-3), and a Final Score Submodule (440-4).

The User Information Tracking Module (430-17) saves information about each user (FIG. 1, 103). The information saved may be participating businesses (FIG. 1, 107) a user (FIG. 1, 103) has been to, what days they have redeemed coupons, participating businesses (FIG. 1, 107) where the user (FIG. 1, 103) is a first-time customer, when a user (FIG. 1, 103) has come back to a participating business (FIG. 1, 107) a second time, what time they redeemed a coupon, which coupon they used next, or which participating business (FIG. 1, 107) they visited next. A unique identifier is associated with the information stored with each user (FIG. 1, 103). This allows the computer system to identify which stored information is associated with which user (FIG. 1, 103).

The stored groupings module (430-18) receives information from the user information tracking module (430-17) and stores groupings which consist of the coupons and the associated locations of 2 or more participating businesses (FIG. 1, 107). A grouping is a list or collection of two or more items stored on the non-transitory storage medium (425) of the computer system (101). The items of a grouping are coupons and the corresponding participating business (FIG. 1, 107) locations for each coupon that have been redeemed or visited within a time frame threshold. The time frame threshold in preferred embodiments is 18 hours, but may be shorter or longer depending on the types of business that are being evaluated. The businesses stored in a grouping are also stored in consecutive order based on the order that they were visited by a user. Additionally, in this embodiment, a participating business (FIG. 1, 107) in the grouping cannot be a part of the same category as the previous participating business (FIG. 1, 107). For example, in this embodiment, if a grouping consists of three businesses, the first business and second business may not be from the same category, but the third business may be from the same category of the first business. A category is used to describe businesses with shared characteristics. In this embodiment, the participating businesses (FIG. 1, 107) can be described by the following 3 categories: food, entertainment, and recreation. In other embodiments, additional categories may be used such as pizza restaurant, dessert shop, kids theme park, movie theater, or Italian restaurant. In other embodiments, a participating business (FIG. 1, 107) that fits under multiple categories may be described by multiple categories, or a single category with two characteristics, such as one category for business that correspond to both food and entertainment. The time frame threshold may be modified, but in this embodiment, the time frame threshold is 18 hours. In some embodiments the range of the time frame threshold is between 0 and 18 hours, 0.1 and 18 hours, 0 and 200 hours, 0.1 and 200 hours, as well as other ranges inclusive of the above-mentioned ranges. Each grouping is passed to the pairing module which assigns a score to each grouping before being passed back to the Stored Groupings Module (430-18). The Business Location Receive Module (430-1) will receive the coupons, other business information, and geolocations of the participating businesses (FIG. 1, 107) for groupings with the highest scores and display them to the user (FIG. 1, 103).

The Pairing Module (430-19) receives groupings from the Stored Groupings Module (430-18) and assigns a score to each grouping before returning each grouping with a score back to the Stored Groupings Module (430-18). The score may be a numerical score or any other score, such as a score comprising letters, that identifies which groupings are most or more desirable and which groupings are least or less desirable. In the preferred embodiment, a higher numerical score indicates a more desirable grouping. The score is determined by the Final Score Submodule (440-4) which adds up multiple subscores determined by multiple Score Submodules (440). Each Score Submodule (440) evaluates a given grouping using a different qualitative or quantitative quality such as distance or size. Within each Score Submodule (440), each qualitative or quantitative quality is broken up into ranges. Each range within the Score Submodule (440) is associated with a different score. The Score Submodule (440) will output a score for the grouping based on which range the grouping falls within. In this embodiment there are 3 Score Submodules (440) that use quantitative criteria.

The Time Range Score Submodule (440-1) uses time range as a criteria for evaluating groupings. In some embodiments, the time range is a decimal number representing the number of hours that have elapsed between the redemption of the first coupon in the grouping to the last coupon in the grouping. The time range evaluated by the Score Submodule (440-1) for a particular grouping may be an average of the time ranges for every such grouping combination with a unique user identifier. In some embodiment, there are a plurality of ranges of hours such as 0.1-3 hours for a first range, 3.1-5 hours for a second range, and 5.1-18 hours for a third range. A lower time range may denote a better set of coupons, thus resulting in a higher score. A score may be associated with each range. In some embodiment, when the coupons fall in the first range, then the Time Range Score Submodule (440-1) outputs a time range score of 0.8, 0.5 for the second range, and 0.3 for the third range.

The Distance Score Submodule (440-2), in some embodiments, uses distance as a criteria for evaluating groupings. In some embodiments, the distance is a decimal number which represents the total distance a customer must travel between the participating business (FIG. 1, 107) locations in the grouping. For some embodiments, there are a plurality of ranges of distances, such as 0.1-3 miles for a first range, 3.1-15 miles for a second range, and 15.1-50 miles for a third range. A lower distance range may denote a better set of coupons, and thus a higher score. For some embodiments, when the distance of the business for which a coupon is presented falls in the first range, there would be an outputted time range score of 0.8, a score 0.5 if the distance of the business falls within the second range, and a score of 0.3 if the distance falls within the third range.

In some embodiments, a Score Submodule (440-3) uses the number of unique users as a criteria for evaluating groupings. The number of unique users may be determined by the number of users (FIG. 1, 103) with unique user identifiers stored with the computer system who have used the same coupons or visited the same participating businesses (FIG. 1, 107) as the participating businesses in a grouping. A grouping with a higher number of unique users denotes a better set of coupons, and in this embodiment results in a higher Unique User's score. In the preferred embodiments, there are a plurality of ranges. In some embodiments, there are 3 ranges: a first range of 1-5 users, a second range of 6-15 users, and a third range of greater than 16 users. In this embodiment, if the number of users fell into the first range, the Unique Users score would be a lower number such as 0.3, a higher number for the second range such as 0.5, and an even higher number for the third range such as 0.8.

While this embodiment only contains 3 score submodules, other score submodules can be created containing different criteria with each associated score.

The Final Scores Submodule (440-4) will add up the scores from all the submodules creating a final score for the grouping passed to the Pairing Module (430-19). There is a criteria used to automatically reject a grouping found in the Final Scores Submodule (440-4). Regardless of the scores of the other Score Submodules (440), if a grouping meets the failure criteria, then the final score is 0 or some other code which represents that the grouping is not desirable. In this embodiment, the failure criteria is the following: the categories do not include 2 or more different categories or the first 2 consecutive activities in the grouping are of the same type.

The Smart Suggestions Module (443) also receives information from the User Information Tracking Module (430-17) about what coupons all Users (FIG. 1, 103) have used. Based on the current coupons a certain User (FIG. 1, 103) has used, the Smart Suggestions Module may suggest Participating Businesses (FIG. 1, 103) that this User (FIG. 1, 103) has not visited, but other Users (FIG. 1, 103) who have visited the same Participating Businesses (FIG. 1, 103) as this User have also visited. Additionally, in this embodiment, for each coupon, the Smart Suggestions Module (433) will keep track of which coupon was most often redeemed after a User (FIG. 1, 103) used that coupon. The Smart Suggestions Module (433) may then use that information to suggest the Participating Business (FIG. 1, 107) corresponding to that next coupon to the Business Location Receive Module (430-1) after a User (FIG. 1, 103) has redeemed a coupon.

FIG. 4C illustrates another embodiment of the computer system (101) as depicted in FIG. 4A, but with an additional module. FIG. 4C illustrates how the additional module allows the computer system (FIG. 1, 101) to create more helpful feedback to the participating business (FIG. 1, 107) by only allowing certain users (FIG. 1, 103) to create reviews who are customers of the participating business (FIG. 1, 107) or have experienced the services of the participating business sufficiently to be an informed reviewer. The computer system (101) includes a processor (421), a Network Interface (426), a Time Measurement device (427), and a non-transitory storage medium connected by a communication bus (424).

The Non-Transitory Storage Medium (425) includes Other Modules (800-2), a Business Location Receive Module (430-1), a Business Time Usage Module (430-2), a Business Usage Module (430-3), a Reporting Module (430-4), a Business Receive Module (430-6), and a Customer Review Module (430-11).

Other Modules (800-2) represents the other modules in the Non-Transitory Storage Medium (425) represented in FIG. 4A that, for this embodiment, are not necessary to understand how the additional module works.

The Business Location Receive Module (430-1) will receive a number of locations for Participating Businesses (FIG. 1, 107) by communicating with the Server (FIG. 1, 105) through the Communication Bus (424), and Network Interface (426). The Pairing Module (FIG. 4B, 430-19), Stored Groupings Module (FIG. 4B, 430-18), and Smart Suggestions Module (FIG. 4B, 430-20) may be used to determine which Participating Business (FIG. 1, 107) locations to receive.

The Business Receive Module (430-6) will receive information through the Server (FIG. 1, 105) from Participating Businesses (FIG. 1, 107) associated with the locations received by the Business Location Receive Module (430-1). This information from Participating Businesses (FIG. 1, 107) allows scheduling and communication through the computer system (FIG. 1, 101). The information may also include metadata, coupons, video and graphics, and promotions from the corresponding Participating Businesses (FIG. 1, 107). A User (FIG. 1, 103) may view Participating Businesses (FIG. 1, 107) through the User Display (423), the hours that the business is open, as well as any corresponding events, coupons, or promotions for products and services offered by the Participating Businesses (FIG. 1, 107).

The Business Time Usage Module (430-2) contains a business time usage goal for each Participating Business (FIG. 1, 107). This business time usage goal is the minimum amount of time a User (FIG. 1, 103) must be within a certain radius of the Participating Business (FIG. 1, 107) location in order to be considered a customer of the business or a person who is not a customer but has experienced the Participating Business (FIG. 1, 107) enough to write a well-informed review.

The Business Usage Module (430-3) obtains the User (FIG. 1, 103) geolocation from the global positioning system (433) and compares the current User (FIG. 1, 103) geolocation with Participating Business (FIG. 1, 107) geolocations. If the current location of a User (FIG. 1, 103) corresponds to the location of a Participating Business (FIG. 1, 107), then the User (FIG. 1, 103) is able to redeem a promotion or coupon associated with the corresponding Participating Business (FIG. 1, 107). The Business Usage Module (430-3) also communicates with the Time Measurement device (427) to monitor the amount of time the User (FIG. 1, 103) is at the geolocation by comparing the amount of the time the User (FIG. 1, 103) is at the location of the Participating Business (FIG. 1, 107) to the business time usage goal from the Business Time Usage Module (430-2).

The Customer Review Module (430-21) allows Users (FIG. 1, 103) to create reviews for the products or services of a Participating Business (FIG. 1, 107). These reviews may contain text, video, or pictures about a User's (FIG. 1, 103) experience at the Participating Business (FIG. 1, 107) and their satisfaction with the products and services offered. The customer reviews may be viewed by other Users (FIG. 1, 103), and the content of the reviews is passed to the Reporting Module (430-4) which communicates that information through the Communication Bus (424) to the Server (FIG. 1, 105). The corresponding customer reviews are also able to be accessed and viewed by Participating Businesses (FIG. 1, 107). If a User (FIG. 1, 103) is determined by the Business Usage Module (430-3) to have been within a certain radius of the Participating Business (FIG. 1, 107) location greater than the business time usage goal, then the Customer Review Module (430-21) will allow the User (FIG. 1, 107) to create a customer review. Only Users (FIG. 1, 103) who have been determined to meet the business time usage goal will have access to create a customer review.

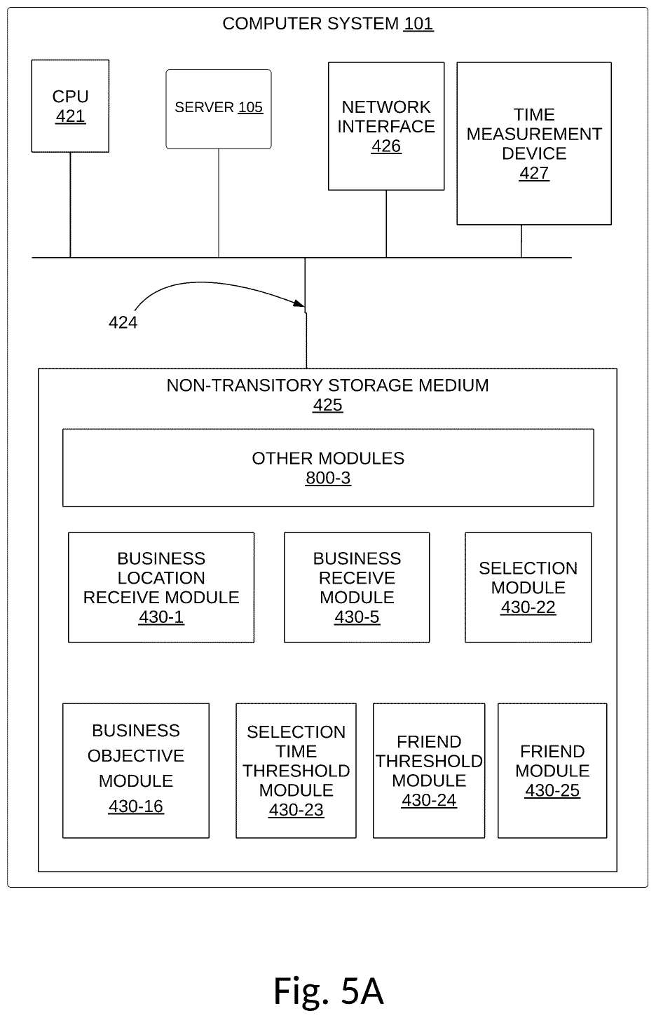

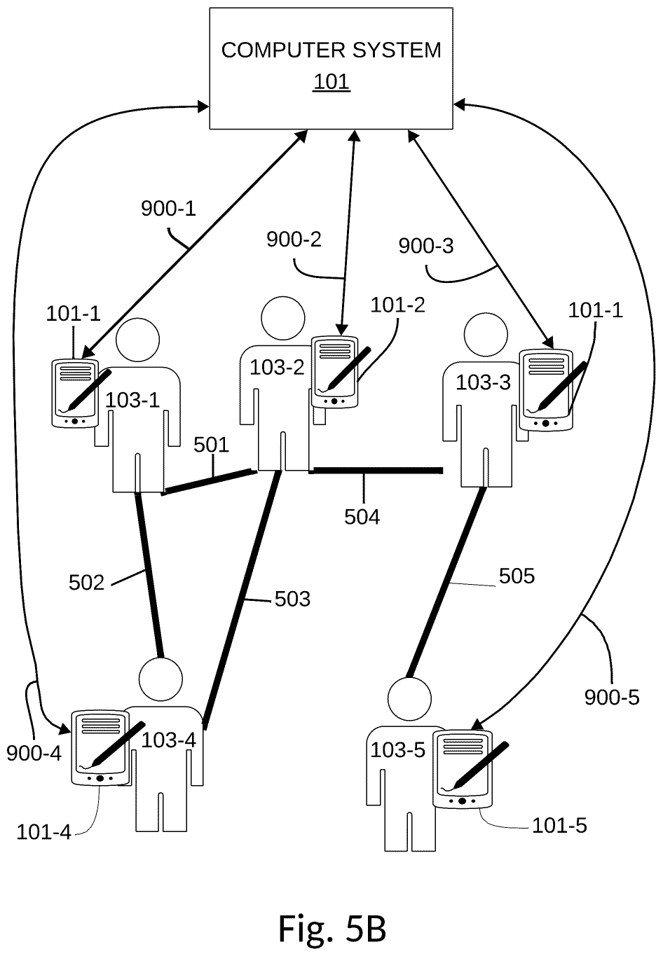

FIG. 5A illustrates another embodiment of the computer system (101) as depicted in FIG. 4A, but with additional modules. FIG. 5A illustrates how these additional modules allow the computer system (101) to determine when a group of friends is likely to become a customer at a Participating Business (FIG. 1, 107). These additional modules also allow the computer system (101) to connect Users (FIG. 1, 103) who are friends or who do not know each other with others that are interested in the same products or services offered by Participating Businesses (FIG. 1, 107). The computer system (101) includes a processor (421), a Network Interface (426), a Time Measurement device (427), and a Non-Transitory Storage Medium (425) connected by a Communication Bus (424).

The Non-Transitory Storage Medium (425) includes Other Modules (800-3), a Business Location Receive Module (430-1), a Business Receive Module (430-5), a Business Objective Module (430-16), a Swipe Module (430-22), a Selection Time Threshold (430-23), a Friend Threshold Module (430-24), and a Friend Module (430-25). Other Modules (800-1) represents the other modules in the Non-Transitory Storage Medium (425) represented in FIG. 4A that, for this embodiment, are not necessary to understand how the additional modules work.

The Business Objective Module (330-11) receives business objectives for corresponding Participating Businesses (430-16). The business objective contains information from the business that may be used to determine which offers, specials, discounts, or other deals are presented for a user of the computer system (101) to assist the Participating Business (FIG. 1, 107) in obtaining its objective. This may include content such as videos and graphics that promote the products and services of a Participating Business (FIG. 1, 107). This content may or may not include coupons. The business objective may contain a specific demographic and/or region that the promotional content is supposed to reach. The business objective may also include a group of Users (FIG. 1, 103) that fit certain characteristics based on information obtained from the Users (FIG. 1, 103) through the Preference Receive Module (FIG. 1, 430-12) or saved from the User's (FIG. 1, 103) usage of the computer system (FIG. 1, 101) in the User Information Tracking Module (330-17).

The Business Location Receive Module (430-1) will receive a number of locations for Participating Businesses (FIG. 1, 107) by communicating with the Server (FIG. 1, 105) through the Communication Bus (424), and Network Interface (426) through a similar process as how the Business Location Receive Module (430-1) receives locations as described in FIG. 4C.

The Business Receive Module (430-6) receives information through the Server (FIG. 1, 105) from Participating Businesses (FIG. 1, 107) associated with the locations received by the Business Location Receive Module (430-1). This information from Participating Businesses (FIG. 1, 107) allows scheduling and communication through the Computer system (FIG. 1, 101). The information may also include metadata, coupons, video and graphics, and promotions from the corresponding Participating Businesses (FIG. 1, 107). A User (FIG. 1, 103) may view Participating Businesses (FIG. 1, 107) through the User Display (423), the hours that the business is open, as well as any corresponding events, coupons, or promotions for products and services offered by the Participating Businesses (FIG. 1, 107).

The Friend Module (461) contains information about which of the other Users (FIG. 1, 103) are connected as a friend to a particular user. The Friend Module (461) also allows users to search up other users by an identifier which may be a phone number, username, email address, or code.

The Selection Time Threshold Module (463) contains information on the time range that Users (FIG. 1, 103) must all indicate interest in an activity within, such as by swiping upwards on a device screen or selecting a button, in order to be grouped together. Some nonlimiting examples of time ranges are 0 hours to 4 hours, 0 hours to 2 hours, 0 hours to 24 hours, 0 hours to 1 week, 0 hours to one month; other ranges are contemplated and included.

In some embodiments, a Friend Threshold Module (462) contains a friend threshold of a minimum number of friends for each coupon or activity defining how many Users (FIG. 1, 103) who are connected as friends must indicate their interest in a coupon or activity within the time frame indicated by the Selection Time Threshold Module (463) before the Users (FIG. 1, 103) involved are notified and/or a coupon or promotion is sent to the group of Users (FIG. 1, 103). Some nonlimiting examples of the friend threshold are 2 friends, 3 friends, greater than 2 friends, greater than 3 friends, greater than 4 friends, between 3 friends and 10 friends inclusive, or greater than 10 friends.

The Selection Module (460) displays the promotional content received from the Business Objective Module (430-16) to the User display (423). This content may include information about available products and services from Participating Businesses (FIG. 1, 107). A User (FIG. 1, 103) can indicate through the User Display (423) that they are interested in a product or activity from the promotional content received from the Business Objective Module (430-16). They may also indicate that they are not interested in a product or activity. In preferred embodiments, a user would indicate their interest in their activity swipe up on the page displaying the activity and they would swipe down to indicate they are not interested in an activity. Other methods may be used or combined to allow the User (FIG. 1, 103) with more or different options to indicate interest or disinterest such as giving the User (FIG. 1, 103) the option of pressing buttons or icons on the User Display (423) to indicate their interest. In one embodiment of the Selection Module (460), when a User (FIG. 1, 103) indicates their interest in an activity, the Selection Module (460) communicates with the friend module to determine if any of the User's (FIG. 1, 103) friends have also indicated interest for that activity. When friends of the User (FIG. 1, 103) indicate interest in the same activity, the Selection Module communicates with the Selection Time Threshold Module (430-23) to determine if the time frame between the swipes of the User (FIG. 1, 103) and their friends is within the time range indicated by the Selection Time Threshold Module (430-23). For example, a time range could be 24 hours. For the Users (FIG. 1, 103) who meet the criteria, the computer system (101) instructs the smart device to display on the User Display (423) for each User (FIG. 1, 103) other users who have met the same criteria. In another embodiment, all people who have indicated that they want to view and be viewed by users who are not friends with them may view from the user interface all of the other Users (FIG. 1, 103) within a certain geographic radius who have also indicated interest on the same activity within the time threshold contained in the selection time Threshold Module (463).

FIG. 5B illustrates in greater detail an example of how the computer system (101) uses the modules described in FIG. 5A to communicate and receive information from several users through several smart devices. Communicating with a user through a smart device is an example of a method that the computer system uses to gather information. In the preferred embodiments the computer system does not have the smart devices used by a user. FIG. 5b illustrates how the computer system may communicate with a number of smart devices. The diagram shown in FIG. 5B shows the computer communicating with five devices; however, the computer may communicate and function with only a single device or more than five devices. The computer system (101) may communicate with one smart device, communicate with more than one smart device at the same time, or communicate with a plurality of smart devices at different times. FIG. 5B contains a computer system (101) communicating (900-1) with a first smart device (101-1), communicating (900-2) with a second smart device (101-2), communicating (900-3) with a third smart device (101-3), communicating (900-4) with a fourth smart device (101-4), and communicating (900-5) with a fifth smart device (101-5). A first user (103-1), using the first smart device (101-1) communicates (900-1) with the computer system (101); a second user (103-2), using the second smart device (101-2) communicates (900-2) with the computer system (101), a third user (103-3), using the third smart device (101-3) communicates (900-3) with the computer system (101), a fourth user (103-4), using the fourth smart device (101-4) communicates (900-4) with the computer system (101), and a fifth user (103-5), using the fifth smart device (101-5) communicates (900-5) with the computer system (101), with each communicating as illustrated in FIG. 1 in the same way that the first user (FIG. 1, 103) uses the first smart device (FIG. 1, 101-1) to communicate with the computer system (101). A first friend connection (501) illustrates that the first user (103-1) and the second user (103-2) are friends. A second friend connection (502) illustrates that the first user (103-1) and the fourth user (103-4) are friends. A third friend connection (503) illustrates that the second user (103-2) and the fourth user (103-4) are friends. A fourth friend connection (504) illustrates that the second user (103-2) and the third user (103-3) are friends. A fifth friend connection (505) illustrates that the third user (103-3) and the fifth user (103-5) are friends. The information indicating the first friend connection, the second friend connection, the third friend connection, the fourth friend connection, the fifth friend connection is stored on the non-transitory storage medium (425) of the computer system (101).

In one example, the Business Objective Module (FIG. 5A, 430-16) receives data identify an activity from a Participating Business (FIG. 1, 107) and displays information about the activity to the User Display (423) of the first smart device (101-1), the second smart device (101-2), the third smart device (101-3), the fourth smart device (101-4), and the fifth smart device (101-5). The first user (103-1), The second user (103-2), The third user (103-3), The fourth user (103-4) and The fifth user (103-5) swipe up within 24 hours indicating that they are interested in the activity. The time range contained in the selection time Threshold Module (FIG. 5A, 430-23) is 24 hours, and the Friend Threshold Module (FIG. 5A, 430-24) contains a friend threshold of 2 friends. To satisfy the threshold, a person who swiped up must also have 2 friends who swiped up. The first user (103-1) swiped up and has 2 friends, The second user (103-2) and The fourth user (103-4), who also swiped up. The Selection Module (FIG. 5A, 430-22) would notify The first user (103-1) which 2 of his friends also swiped up on the activity. In this example, the Business Objective Module (FIG. 5A, 430-16) contains a business objective associated with the Participating Business (FIG. 1, 107) which the Users (101) swiped up on. In this case, the business objective contained instructions to send a promotion or coupon to a group of friends who all swiped up on the promotional activity. Thus, The first user (103-1), The second user (103-2), and The fourth user (103-4) collectively receive the promotion or coupon associated with the participating business (FIG. 1, 107) activity that they selected, such as making a swiping gesture on a screen of their smart device. From the other user's perspectives, The second user (103-2) would see that The first user (103-1), The third user (103-3), and The fourth user (103-4) swiped up, and all of them would receive the promotion or coupon. The third user (103-3) would see that the second user (103-2) and the fifth user (103-5) swiped up. The fourth user (103-4) would see that the first user (103-1) and The second user (103-2) swiped up. The fifth user would only see that the third user (103-5) swiped up. From the perspective of The fifth user, only 1 of her friends swiped up which would normally not satisfy the threshold of 2 in the Friend Threshold Module (FIG. 5A, 430-24). However, since The third user (103-3) has 2 friends, The second user (103-2) and The fifth user (103-5), The third user (103-3) meets the threshold, and all of his friends who swiped within the time threshold in the selection time Threshold Module (FIG. 5A, 430-23) would be sent the coupon. If all the Users (103) turned on that they want to view non-friends who have also swiped up on activities, every User (103) would be able to see on their User Display (FIG. 5A, 423) all other Users (103), even those who are not connected as friends.

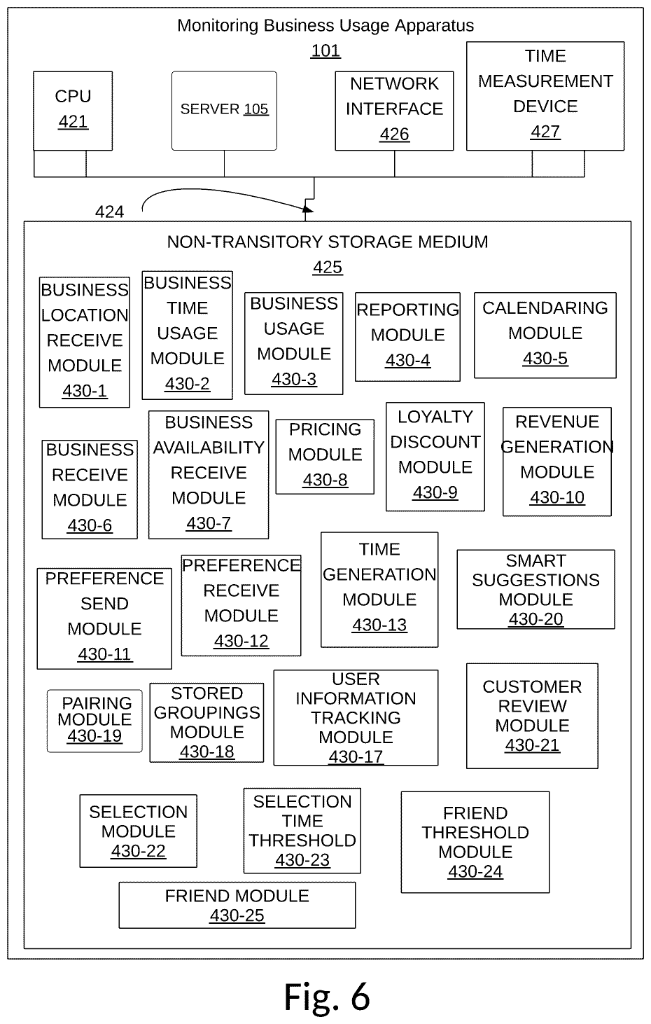

FIG. 6 illustrates another embodiment of the computer system (101) which contains all the Modules (430) which are described in FIG. 4A, FIG. 4B, FIG. 4C, and FIG. 5A, illustrative of how the computer system (101) may contain some of those modules previously described, and that the modules may still perform their functions even when all stored on the same Non-Transitory Storage Medium (425)

FIG. 7 is an example of a user interface of a smart device communicatively-coupled to computer system (101) for displaying activities selectable by a user. In this example, no activities have been selected by a user of a smart device communicatively-coupled to the computer system (101). The user is provided with various opportunities such as food, art, entertainment and recreation. Additionally, activities may be selected based on geographic location using a map, or using a friend.

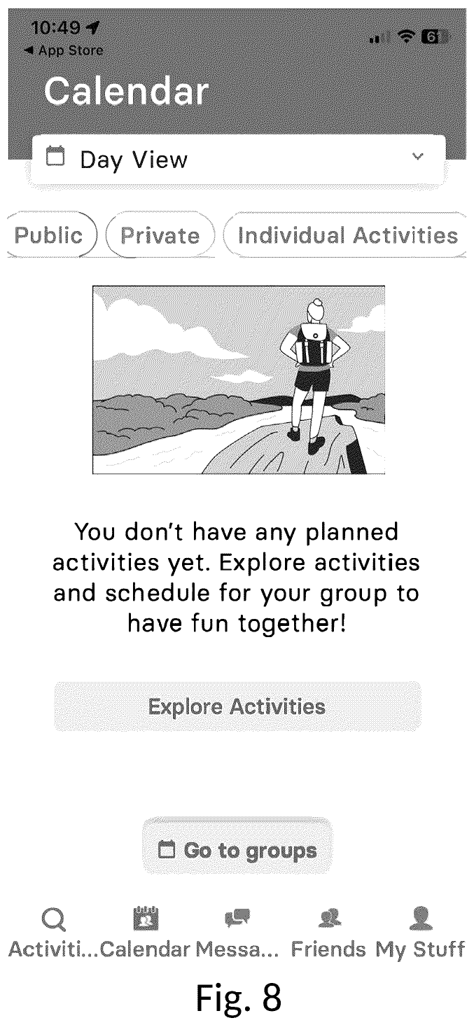

FIG. 8 illustrates an example of a user interface for calendaring activities using a smart device communicatively-coupled to computer system (101). In this example, no activities have been scheduled for the user. The user is provided with various opportunities to explore groups and activities.

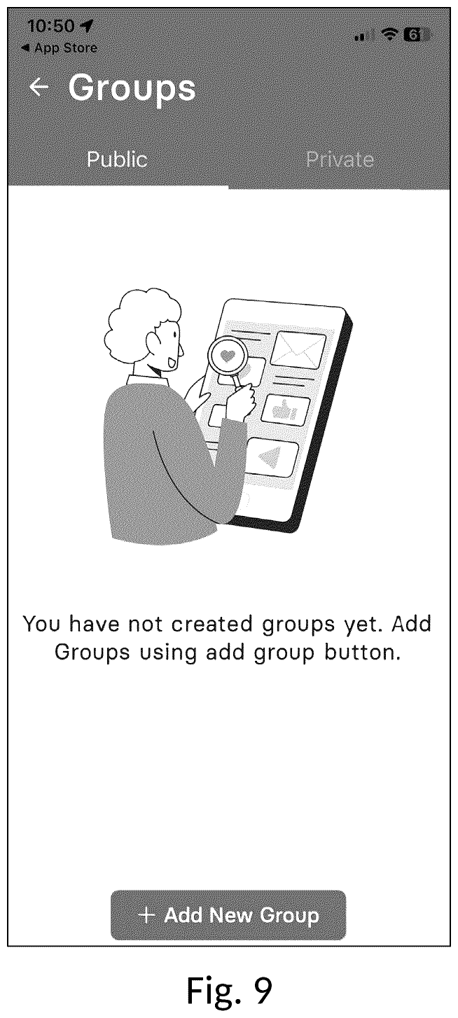

FIG. 9 illustrates an example of a user interface for display on a smart device for group selection.

No groups have been identified and the user is given the opportunity to join both public and private groups.

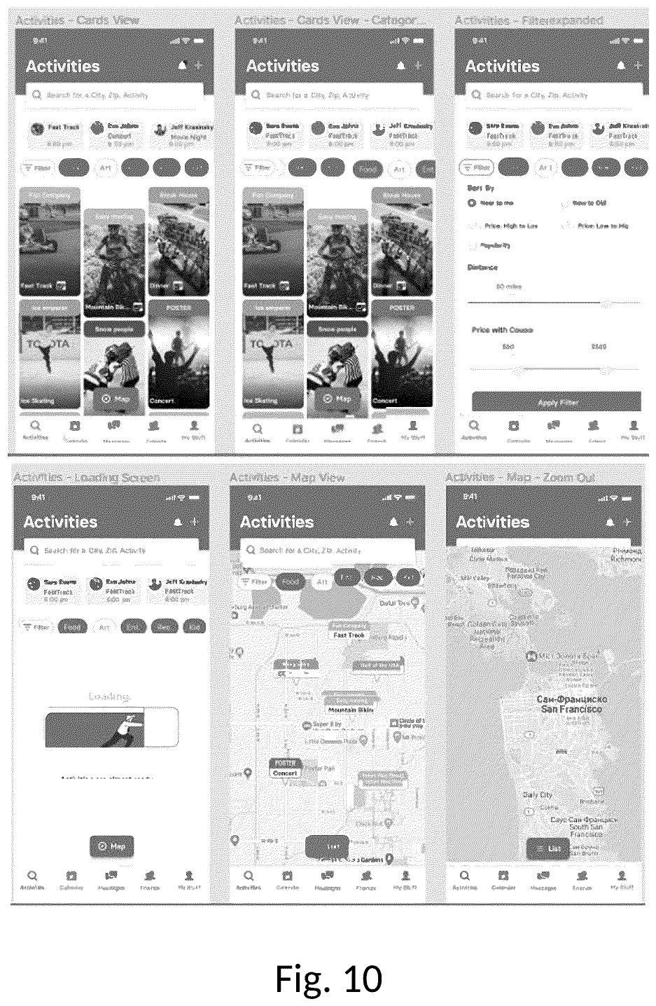

FIG. 10 illustrates an example of user interfaces for display on a smart device. A user has a number of activities that have been scheduled including go-karting, ice skating, mountain biking, concerts, and other activities. Activities may be selected within a geographic range, which may be displayed on a map.

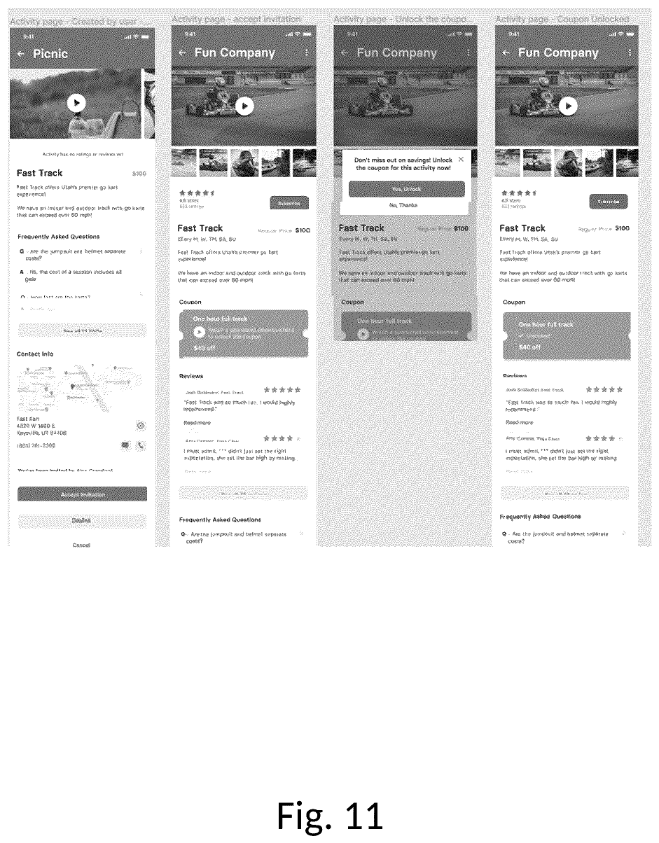

FIG. 11 illustrates an example of user interfaces for display on a smart device. An activity may include locations, price, and reviews that provide a user with information that may be available for the user.

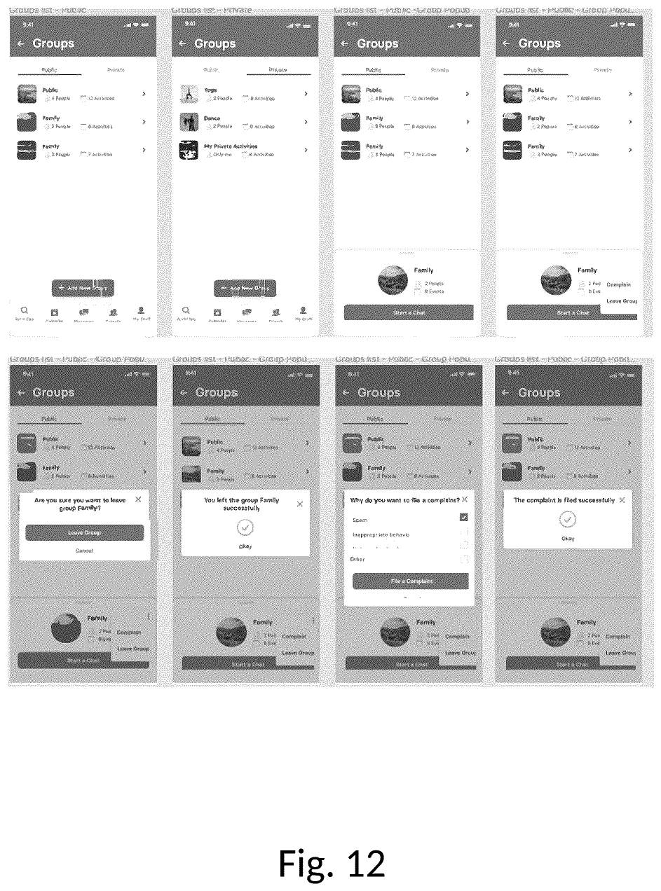

FIG. 12 illustrates an example of user interface for users to select group participation using a smart device. Groups may include a number of individuals that a user may wish to associate with. Groups may include people with common interests. Additionally, groups may be managed so that problems or users within the group to prevent undesirable activities.

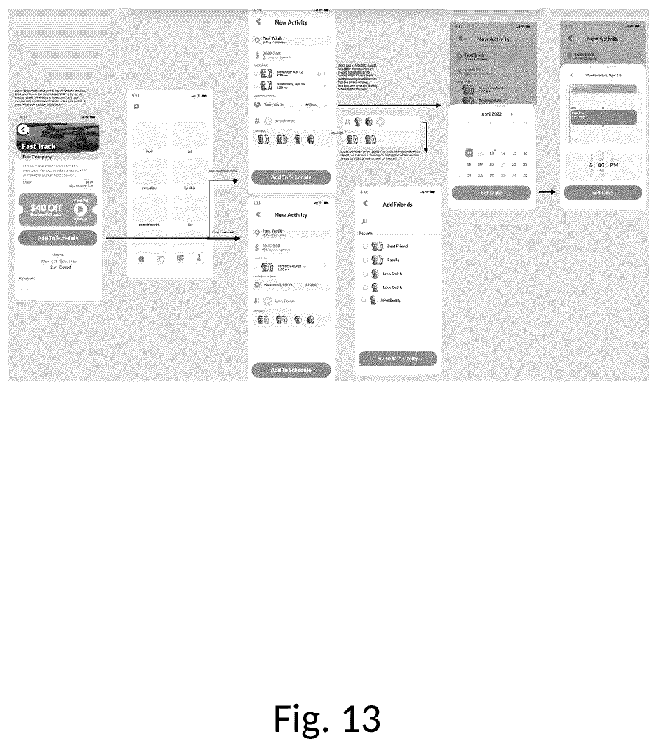

FIG. 13 illustrates an example of a user interface for inviting a number of friends to a group activity. In this example, a user may select an activity. The time the user selects is based on members of groups associated with the user so the user may select a time for the activity to allow association with other groups.

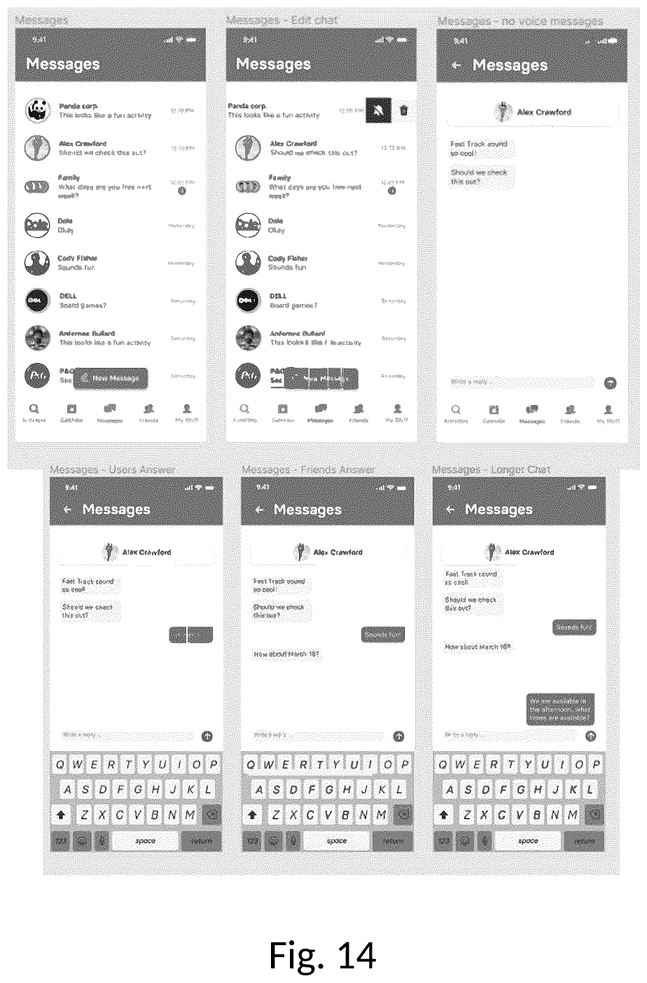

FIG. 14 illustrates an example of user interfaces for display on a smart device using messages to coordinate an activity using the computer system. Users may wish to communicate and coordinate common participation in an activity of deal.

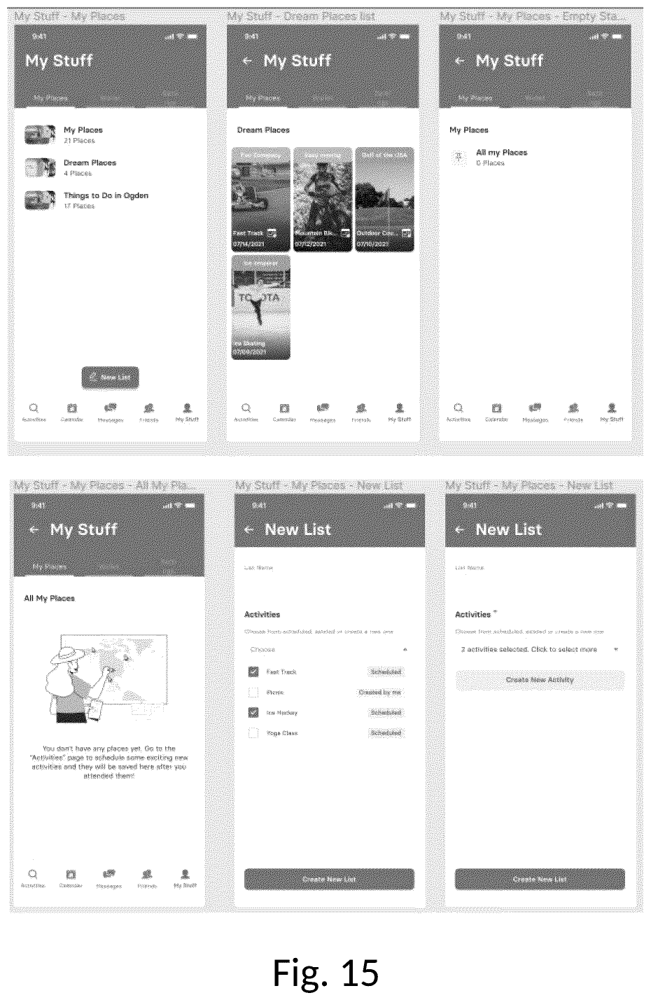

FIG. 15 illustrates an example of user interfaces, for displaying on a smart device, selections associated with a user using the computer system (101). The selections may include categories of various activities, including activities such as favorites, regional activities, or goal activities.

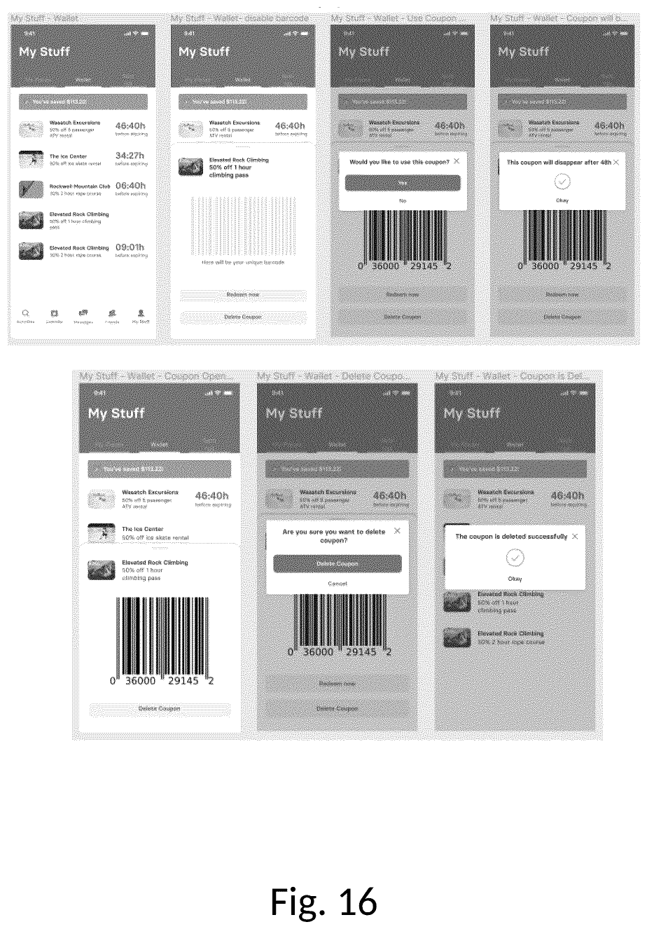

FIG. 16 illustrates an example of user interfaces, for displaying on a smart device, selections associated with a user using the computer system (101). Selections may include coupons identified by number, bar code, quick-response code, or associated with a device. Coupons may have restrictions as to time for usage or expiration dates. Users may add, save, or delete coupons.

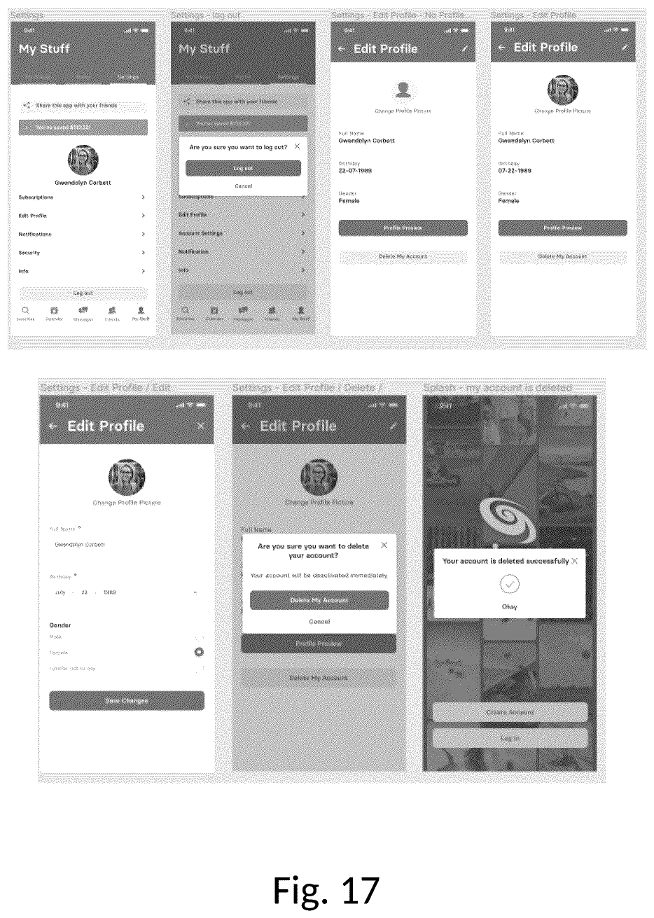

FIG. 17 illustrates an example of user interfaces, for displaying on a smart device, for configuring a user profile using the computer system (101). The profile may provide suggested activities based on user demographics or preferences.

Methods using the disclosed embodiments of the computer system are disclosed and contemplated herein.

What is claimed:

1. A computer system for monitoring business usage, the computer system comprising:
a processor;
a network interface card, communicatively connected to the processor;
a time measurement system, the time measurement system communicatively connected to the processor;
a non-transitory computer-readable storage medium, the non-transitory computer-readable storage medium comprising a number of modules, each module consisting of a combination of hardware and computer code that cause the processor to cause the computer system to perform a particular task, the modules comprising:
a business location receive module, the business location receive module receiving, using the network interface,
a plurality of participating business identifiers wherein each participating business identifier corresponds to a participating business entity of a plurality of participating business entities, and
a plurality of sets of global positioning system coordinates wherein each set of global positioning system coordinates corresponds to one of the plurality of participating business identifiers;
a business time usage module, the business time usage module receiving a plurality of business time usage goals wherein each of the plurality of business time usage goals corresponds to one of the plurality of participating business identifiers;
a business usage module, the business usage module determining whether a first user was physically proximate to the one of the plurality of participating business entities for at least a length of time equal to or greater than the business time usage goal corresponding to the one of the business entities, wherein after the business usage module has determined that the first user was physically proximate to the one of the plurality of participating business entities for at least a length of time equal to or greater than the business time usage goal corresponding to the one of the participating business entities, then the business usage module stores, in the business usage module, a designation of customer status of the one of the participating business entities for the first user and instructs a customer review module to send a request to the first user requesting that the first user provide customer feedback to the computer system about the one of the business entities.

2. The computer system in claim 1, wherein the non-transitory storage medium further comprises:
a calendaring module, the calendaring module receiving scheduled events from businesses and sending instructions, to a smart device of the first user, to display a plurality of scheduled events;
a business receive module, receiving a number of participating business identifiers, each of the number of participating business identifiers identifying a participating business entity, of a plurality of participating business entities, that is configured to schedule reservations made via a smart device communicatively-coupled with the computer system;
a business availability receive module, receiving, for each of the number of participating business identifiers, of the plurality of participating business entities, a number of times for each of the plurality of participating business entities configured to schedule reservations made via the smart device communicatively-coupled with the computer system;
a pricing module, receiving a number of pricing options corresponding to the number of times for each of the plurality of business entities configured to schedule reservations made via the smart device communicatively-coupled with the computer system;
an off-hour business usage module, the off-hour business usage module receiving a set of global positioning coordinates, associated with the smart device, from the smart device and measuring usage of the participating business during off-hours, for each of the number of businesses, by the smart device communicatively-coupled with the computer system.

3. The computer system in claim 2, where a reporting module further reports the usage time at the participating business location as it relates to the number of times for each of the number of participating businesses which is allowing reservations to be scheduled using the computer system determines when the first user used the participating business during a time when the prices were in effect, where the pricing module receives a number of prices for business benefits and times when the prices remain in effect.

4. The computer system of claim 3, further comprising a revenue generation module, the revenue generation module calculating revenue based on the time the first user was present at a participating business and the number of prices for business benefits.

5. The computer system of claim 2, further comprising a business objective module, the business objective module receiving a business objective to direct how the computer system presents content to the first user to help the business achieve its objective.

6. The computer system of claim 5, wherein the reporting module reports an amount of time that the smart device communicatively-coupled with the computer system is physically proximate to the participating business and compares the amount of time to an expected amount of time that the smart device needs to be proximate to a business to demonstrate usage.

7. A computer system for monitoring business usage, the computer system comprising:
a processor;
a network interface card, communicatively connected to the processor;
a global positioning system, the global positioning system communicatively connected to the processor;
a user display, the user display communicatively connected to the processor;
a time measurement system, the time measurement system communicatively connected to the processor;
a non-transitory computer-readable storage medium, the non-transitory computer-readable storage medium comprising a number of modules, each module consisting of a combination of hardware and computer code that cause the processor to cause the computer system to perform a particular task, the modules comprising:
a business location receive module, the business location receive module receiving, using the network interface card, a number of participating business geolocations representing a number of businesses;
a business time usage receive module, the business time usage module receiving a business time usage goal corresponding to one of the number of participating business geolocations, the business time usage goal indicating an amount of time a person would be at the one of the number of business geolocations to be considered a customer of the business;
a business usage module, the business usage module obtaining geolocation data of the first user using the global positioning system communicatively-coupled to the first user's smart device and comparing the first user's geolocation data to the number of business locations to determine when the first user is at one of the number of business geolocations and monitoring the first user geolocation for the time usage goal for a particular geolocation;
a reporting module, the reporting module reporting to a central computer a usage time at a participating business geolocation;
a calendaring module, the calendaring module receiving, scheduling, and displaying scheduled events;
a business receive module, receiving a number of business identifiers, each of the number of business identifiers identifying a participating business that schedules reservations using the computer system;
a business availability receive module, receiving, for each of the number of participating business identifiers, a number of times for each of the number of participating businesses is allowing reservations to be scheduled using the computer system; and
a pricing module, receiving a number of pricing options for each of the number of times for each of the number of participating businesses is allowing reservations to be scheduled using the computer system.

8. The computer system of claim 7, wherein the business usage module further comprises a loyalty reward module, the loyalty reward module providing rewards to the first user of a device for frequenting one of the number of participating business geolocations, the loyalty reward module sending a loyalty reward to the first smart device of the first user, and the business usage module further comprises a loyalty discount module, the loyalty discount module providing rewards to a use of a device for frequenting one of the number of participating business geolocations.

9. The computer system of claim 7, further comprises a related business identifier module, the related business identifier module identifying related participating businesses based on proximity to the user, proximity to the current participating business, the category of the participating business, and the type of participating business.

10. The computer system of claim 7, further comprising a revenue generation module, the revenue generation module calculating revenue generated for a participating business from the first user using the computer system.

11. The computer system of claim 7, further comprising a time generation module, the time generation module calculating an amount of time the first user spends at a business using the smart device communicatively-coupled to the computer system.

12. The computer system of claim 7, further comprising a preference receive module and a preference send module, the preferences receive module receiving using a computer input device, a number of preferences for the first user, and the preference send module sending the preferences to a server which are used by the computer system as a factor in determining which participating business geolocations and participating business promotional content that are sent by the computer system to the smart device of the user.

13. The computer system of claim 7, further comprising:
a user information tracking module, the user information tracking module storing usage information of each user, the information stored being information about coupons the first user has redeemed, participating businesses the first user has been a customer, and other information about the first user's behavior used to predict what business would appeal to the first user next, with the stored information being identified to the user the information was obtained from with a unique identifier;
a stored groupings module, the stored groupings module receiving information from the user information tracking module, storing groupings comprising participating businesses and the associated locations of these participating businesses stored as a list in the time order that they were visited by one of a plurality of users, with consecutive participating businesses in the grouping list, which is time ordered, being in different categories, with all businesses in the grouping being visited by a user within a time frame threshold;
a pairing module, the pairing module evaluating a grouping of participating businesses and assigning an identifier signifying groupings that are better combinations to present to users, groupings that are worse combinations to present to users, and an identifier to rank groupings on a spectrum between the best and the worst groupings;
a smart suggestions module, the smart suggestions module receiving information from the user information tracking module about the plurality of users and the participating businesses each user has participated in them, further using this information to suggest participating businesses to be retrieved by the business location receive module and sent to the smart device of the first user that the first user has not visited based on participating businesses other users have visited;
a customer review module, the customer review module allowing users to create reviews for products or services of a participating business, the customer review module also only allowing a user to create a review when the business usage module determines that the user has been at the business long enough to meet the business time usage goal;
a selection time threshold module, the selection time threshold module containing a time range that users must all indicate interest in an activity from a participating business in order to be grouped together for that activity;
a friend threshold module, the friend threshold module containing a friend threshold for each activity from a participating business, the friend threshold defining the number of friends connected to a user who must also indicate interest in an activity in order for the computer system to group them together for that activity; and
a friend module, the friend module containing information about which users are connected as friends, also allowing users to add new friends, look up others by an identifier, and accept friend requests; and,
a selection module.

14. The computer system in claim 7, wherein the selection module displays content received from the business objective module with the selection module allowing the first user and the at least one friend of the first user to communicatively indicate which content received from the business objective module matches preferences of the first user and the at least one friend of the first user.

15. The computer system in claim 14, wherein the selection module communicates with the friend module when the first user indicates interest to determine which of the at least one friends of the first user who have also indicating interest, further communicating with the selection time threshold module to determine when the timeframe between indications of interest meets the selection time threshold, and communicates with the friend threshold module to determine when a number of the at least one friends of the user who have also indicated interest fulfills the friend threshold.

16. The computer system in claim 15, wherein when the friend threshold and the selection time threshold have been fulfilled for the first user and at least one friend of the first user, the selection module allowing the at least one friend of the first user to view a data visualization representing which of the at least one friend of the first user indicated interest in a participating business.

17. The computer system in claim 15, wherein when the friend threshold and selection time threshold are fulfilled for the first user and the at least one friend of the first user, a coupon associated with the activity or participating business for which the first user and the at least one friend of the first user indicated interest is sent by the computer system to the first user, via the smart device of the first user, and the at least one friend, via at least one smart device associated with the at least one friend.

18. The computer system in claim 7, wherein the pairing module further comprises a time range score submodule, a distance score submodule, a unique users score submodule, and a final scores submodule.

19. The computer system in claim 18, wherein the final scores submodule adds up the scores from the time range score submodule, the distance score submodule, and the unique users scores submodule to create a final score for the pairing module to assign to a corresponding grouping, wherein the time range score submodule evaluates the average time range of a grouping, which is the average time between when the business in the grouping was visited to when the last business in the grouping was visited, further determining a score to identify groupings with a high time range, groupings with a low time range, and groupings on spectrum between the highest and lowest time ranges, wherein the distance score submodule evaluates the total distance a user must travel between all the businesses in the grouping, further assigning a score to a grouping which identifies groupings with a high total distance, groupings with a low total distance, and groupings on the gradient between the highest and lowest total distances, and when the unique users score submodule evaluates the total number of unique users who have visited the combination of participating businesses found in a grouping, further assigning a score to a grouping which identifies groupings which have a high number of unique users, groupings which have a low number of unique users, and groupings on the gradient between the highest and lowest number of unique users.

20. A method for monitoring business usage comprising
providing a computer system, the computer system comprising
a processor;
a network interface card, communicatively connected to the processor;
a time measurement system, the time measurement system communicatively connected to the processor;
a non-transitory computer-readable storage medium, the non-transitory computer-readable storage medium comprising a number of modules, each module consisting of a combination of hardware and computer code that cause the processor to cause the computer system to perform a particular task, the modules comprising:
a business location receive module, the business location receive module receiving, using the network interface,
a plurality of business identifiers wherein each business identifier corresponds to a business entity of a plurality of business entities, and
a plurality of sets of global positioning system coordinates wherein each set of global positioning system coordinates corresponds to one of the plurality of business identifiers;
a business time usage module, the business time usage module receiving a plurality of business time usage goals wherein each of the plurality of business time usage goals corresponds to one of the plurality of business identifiers;
a business usage module, the business usage module determining whether a first user was physically proximate to the one of the plurality of business entities for at least a length of time equal to or greater than the business time usage goal corresponding to the one of the business entities, wherein after the business usage module has determined that the first user was physically proximate to the one of the plurality of business entities for at least a length of time equal to or greater than the business time usage goal corresponding to the one of the business entities, then the business usage module stores, in the business usage module, a designation of customer status of the one of the business entities for the first user and instructs a customer review module to send a request to the first user requesting that the first user provide customer feedback to the computer system about the one of the business entities;
determining that the first user was physically proximate to the one of the plurality of business entities for at least a length of time equal to or greater than the business time usage goal corresponding to one of the plurality of business identifiers that corresponds to the one of the plurality of business entities; and
sending a request to the first user requesting that the first user provide customer feedback to the computer system about the one of the business entities.
